(19) United States
(12) Patent Application Publication
(10) Pub. No.: US 2025/0120336 A1
(43) Pub. Date: Apr. 17, 2025

(54) WORKING MACHINE

(71) Applicant: HONDA MOTOR CO., LTD., Tokyo (JP)

(72) Inventors: Takafumi Fukushima, Wako-shi (JP); Hiroki Mukai, Wako-shi (JP); Jun Song, Wako-shi (JP); Yuki Takishima, Wako-shi (JP)

(21) Appl. No.: 18/911,360

(22) Filed: Oct. 10, 2024

Related U.S. Application Data
(60) Provisional application No. 63/590,070, filed on Oct. 13, 2023.

(51) Int. Cl. A01D 34/00; A01D 75/20; A01D 101/00; G01S 13/86; G01S 13/931; G06V 20/58

(52) U.S. Cl. CPC A01D 34/006; A01D 34/001; A01D 75/20; G06V 20/58; A01D 2101/00; G01S 13/865; G01S 13/931; G01S 2013/93271; G01S 2013/93272

(57) ABSTRACT

A working machine equipped with vehicle wheels, a working unit, and a recognition unit that recognizes a surrounding vicinity of the working machine.

### CROSS-REFERENCE TO RELATED APPLICATIONS

This application is based upon and claims the benefit of priority from Provisional Application No. 63/590,070 filed on Oct. 13, 2023, the contents all of which are incorporated herein by reference.

### BACKGROUND OF THE INVENTION

### Field of the Invention

The present invention relates to a working machine.

### Description of the Related Art

A working machine is disclosed in Japanese Laid-Open Patent Publication No. 2020-162545 A. This working machine is a riding type of working machine on which a passenger rides. The working machine carries out a lawn mowing operation based on operations of a handle by the passenger.

### SUMMARY OF THE INVENTION

A working machine is desired that is capable of either one from among traveling autonomously and being operated autonomously.

The present invention has the object of solving the aforementioned problem.

An aspect of the present invention is characterized by a working machine comprising vehicle wheels, a working unit, and a recognition unit configured to recognize a surrounding vicinity of the working machine.

According to the present invention, the situation of the surrounding vicinity around the working machine (for example, the working region in which the working machine performs work) can be easily recognized. Accordingly, based on a recognition result of the recognition unit, at least one from among either one of autonomous traveling and autonomous operation of the working machine becomes possible.

The above and other objects, features, and advantages of the present invention will be easily understood from the following description of an embodiment when taken in conjunction with the accompanying drawings.

### BRIEF DESCRIPTION OF THE DRAWINGS

FIG. 1 is a perspective view showing a working machine according to an embodiment of the present invention;

FIG. 2 is a top view of the working machine;

FIG. 3 is a left side view of the working machine;

FIG. 4 is a rear view of the working machine;

FIG. 5 is a top view of the working machine;

FIG. 6 is a left side view of the working machine;

FIG. 7 is a rear view of the working machine;

FIG. 8 is a schematic diagram showing fields of view of LiDAR sensors;

FIG. 9 is a schematic diagram showing fields of view of radar sensors;

FIG. 10 is a schematic diagram showing a field of view of an occupant;

FIG. 11 is a top view of the working machine according to a first exemplary modification;

FIG. 12 is a top view showing a state in which a plurality of the working machines are aligned in a front-to-rear manner; and

FIG. 13 is a top view of the working machine according to a second exemplary modification.

### DESCRIPTION OF THE INVENTION

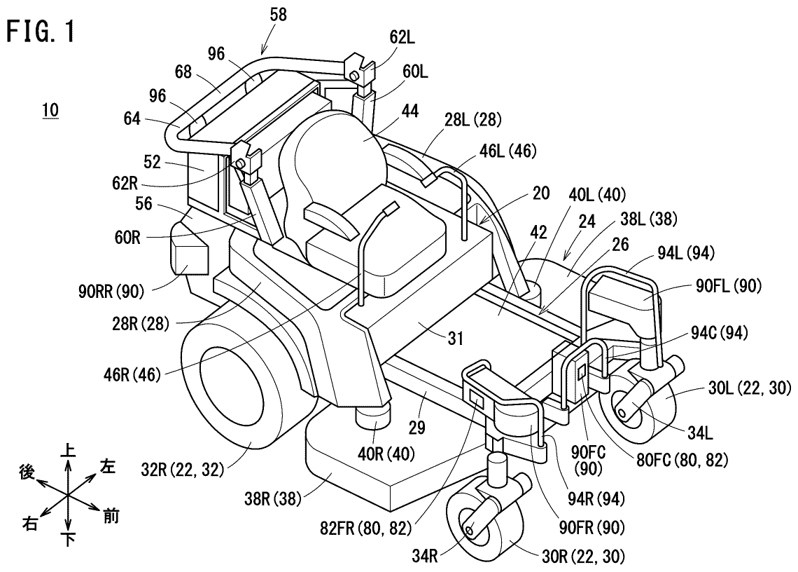

FIG. 1 is a perspective view showing a working machine 10 according to an embodiment of the present invention.

In this instance, the direction in which the working machine 10 moves forward is defined as a frontward direction, and the direction in which the working machine 10 moves rearward is defined as a rearward direction, and a front-rear direction, a left-right direction, and an upper/lower direction (a vertical direction) will be described. Accordingly, the front-rear direction is a direction (a movement direction of the working machine 10) in which the working machine 10 moves forward or moves rearward. Further, the front-rear direction and the left-right direction are horizontal directions of the working machine 10. Furthermore, the upper/lower direction is a direction (a vertical direction) that is perpendicular to the horizontal direction of the working machine 10.

Further, the letter “L” may be appended to the reference numerals indicating constituent elements that are positioned on a left side of the working machine 10. Further, the letter “R” may be appended to the reference numerals indicating constituent elements that are positioned on a right side of the working machine 10. Furthermore, the names of the constituent elements on the left side of the working machine 10 may have the word “left” added thereto. Furthermore, the names of the constituent elements on the right side of the working machine 10 may have the word “right” added thereto.

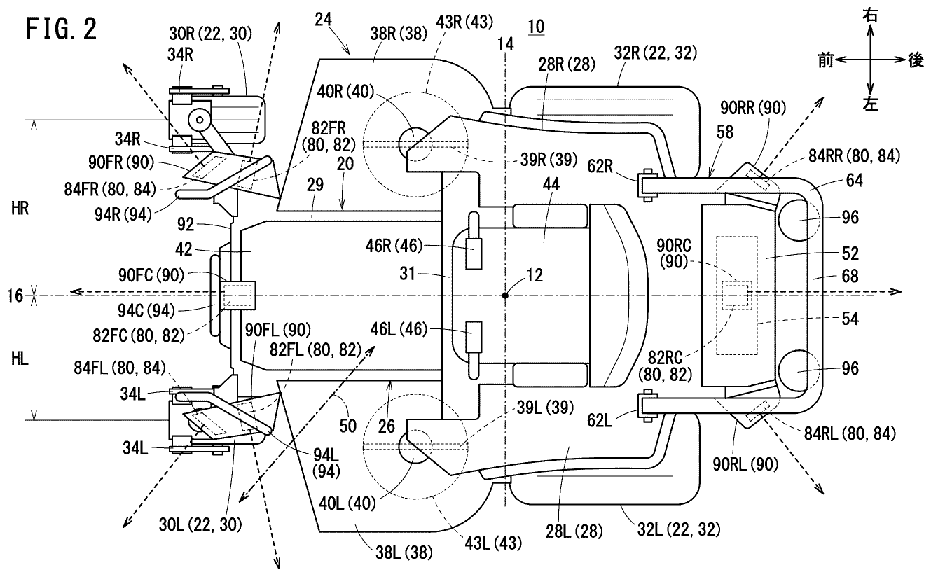

Further, as shown in FIG. 2, in a top view (a plan view when the working machine 10 is viewed from above), a center of the working machine 10 in the front-rear direction and the left-right direction of the working machine 10 is defined as a center point 12 (a front-rear center, a left-right center). A center line that passes through the center point 12 of the working machine 10, and further, extends in the left-right direction is defined as a front-rear center line 14. Accordingly, a portion that is more frontward (on a front side) than the front-rear center line 14 of the working machine 10 is a front side portion (a front part) of the working machine 10. A portion that is more rearward (on a rear side) of the front-rear center line 14 of the working machine 10 is a rear side portion (a rear part) of the working machine 10. A center line that passes through the center point 12 of the working machine 10, and further, extends in the front-rear direction is defined as a left-right center line 16. Accordingly, a portion that is more leftward (on a left side) than the left-right center line 16 of the working machine 10 is a left side portion (a left part) of the working machine 10. A portion that is more rightward (on a right side) than the left-right center line 16 of the working machine 10 is a right side portion (a right part) of the working machine 10. Moreover, in the working machine 10, the letter “C” may be appended to the reference numerals indicating constituent elements that are positioned on the left-right center line 16 or in close proximity to the left-right center line 16.

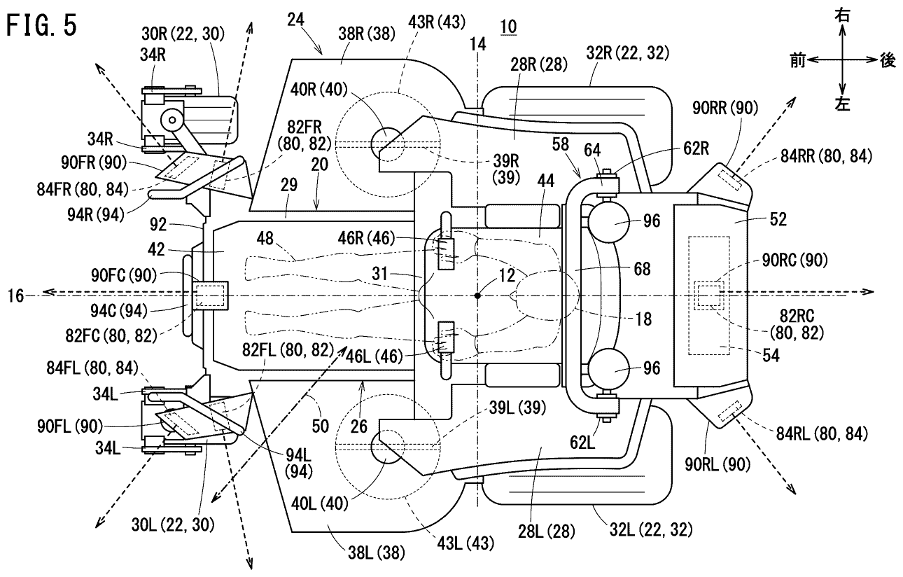

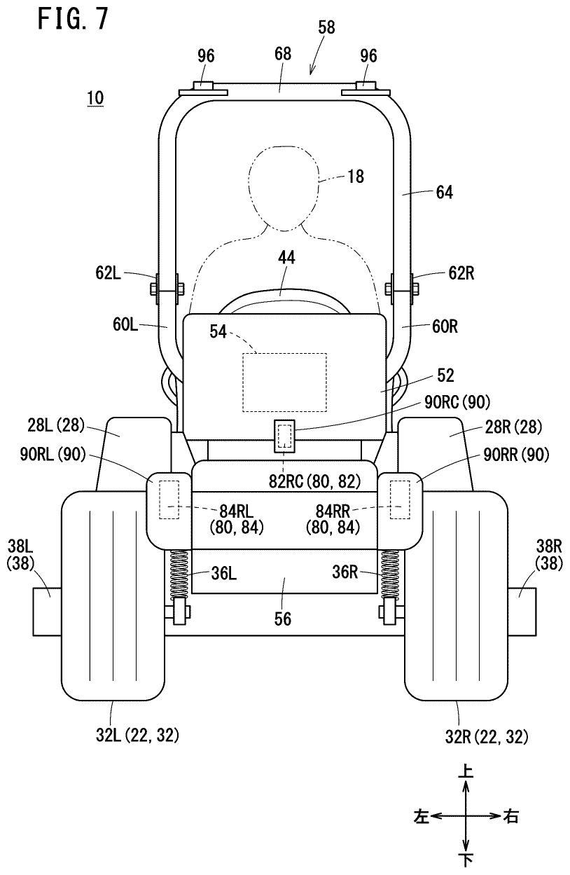

The working machine 10 is a working machine that is capable of either one from among traveling autonomously and being operated autonomously. The working machine 10 is a working machine on which an occupant 18 (a rider) (see FIG. 5 to FIG. 7) is capable of riding. The working machine 10 is a lawn mower. More specifically, the working machine 10 is a riding lawn mower. The lawn mower is a machine that cuts grass.

The working machine 10 is not limited to being a riding lawn mower. The working machine 10 may be a walking type of lawn mower in which the occupant 18 pushes the working machine 10 from behind, or a robotic type of lawn mower that performs an unmanned lawn mowing operation. In the following description, a description will be given concerning a case in which the working machine 10 is a riding lawn mower.

As shown in FIG. 1 and FIG. 2, the working machine 10 includes a machine body 20, a plurality of vehicle wheels 22, and a work deck 24 (working unit).

The machine body 20 includes a vehicle body frame 26, and a cover 28.

The vehicle body frame 26 constitutes a framework of the entire working machine 10. The vehicle body frame 26 extends in the front-rear direction. A front part 29 (a first portion) of the vehicle body frame 26 extends in the horizontal direction. An intermediate part 31 of the vehicle body frame 26 projects out upwardly from a rear end part of the front part 29 of the vehicle body frame 26. A non-illustrated rear part of the vehicle body frame 26 extends rearwardly from the intermediate part 31 of the vehicle body frame 26.

The cover 28 includes a left cover 28L and a right cover 28R. The left cover 28L covers the intermediate part 31 and the left side portion of the rear part of the vehicle body frame 26 from the left. The right cover 28R covers the intermediate part 31 and the right side portion of the rear part of the vehicle body frame 26 from the right

The vehicle wheels 22 include a pair of front wheels 30 (a left front wheel 30L and a right front wheel 30R) and a pair of rear wheels 32 (a left rear wheel 32L and a right rear wheel 32R). The left front wheel 30L and the right front wheel 30R have the same shape and size. The left rear wheel 32L and the right rear wheel 32R have the same shape and size. The left front wheel 30L and the right front wheel 30R are vehicle wheels that have a smaller diameter than the left rear wheel 32L and the right rear wheel 32R. The pair of front wheels 30 are driven wheels. The pair of rear wheels 32 are driving wheels. The left rear wheel 32L is rotated by a non-illustrated left traveling motor. The right rear wheel 32R is rotated by a non-illustrated right traveling motor.

In the working machine 10, the left front wheel 30L and the right front wheel 30R are disposed on a front side (frontwardly) with respect to the front-rear center line 14. In the working machine 10, the left front wheel 30L is disposed more on the front side than the front-rear center line 14, and further, more on the left side than the left-right center line 16. The left front wheel 30L is connected to the left side of the front part 29 of the vehicle body frame 26 via a pair of left front forks 34L. In the working machine 10, the right front wheel 30R is disposed more on the front side (more frontwardly) than the front-rear center line 14, and further, more on the right side than the left-right center line 16. The right front wheel 30R is connected to the right side of the front part 29 of the vehicle body frame 26 via a pair of right front forks 34R.

Moreover, the distance HL between the left front wheel 30L and the left-right center line 16 in the left-right direction is shorter than the distance HR between the right front wheel 30R and the left-right center line 16 in the left-right direction (HL<HR). More specifically, the left front wheel 30L and the right front wheel 30R are disposed asymmetrically with respect to the left-right center line 16.

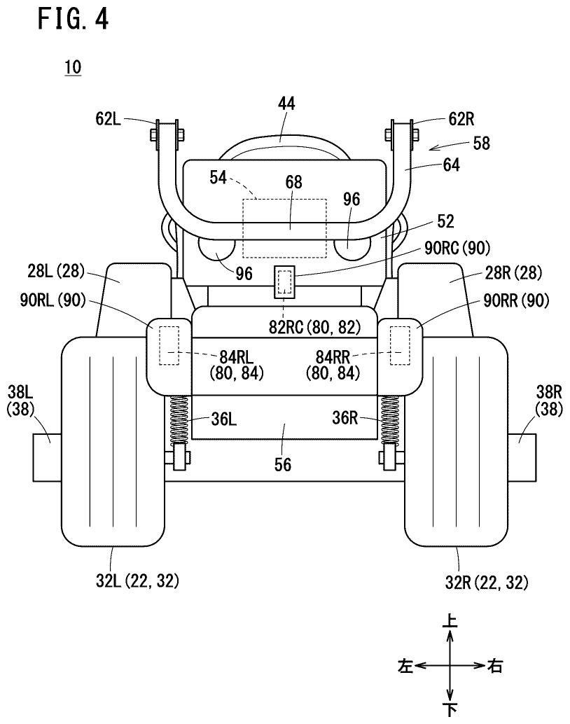

In the working machine 10, the left rear wheel 32L and the right rear wheel 32R are disposed on a rear side (rearwardly) with respect to the front-rear center line 14. In the working machine 10, the left rear wheel 32L is disposed more on the rear side than the front-rear center line 14, and further, more on the left side than the left-right center line 16. The left rear wheel 32L is connected to the left side of the rear part of the vehicle body frame 26, via a non-illustrated left swing arm, and a left suspension 36L (refer to FIG. 4). In the working machine 10, the right rear wheel 32R is disposed more on the rear side than the front-rear center line 14, and further, more on the right side than the left-right center line 16. The right rear wheel 32R is connected to the right side of the vehicle body frame 26, via a non-illustrated right swing arm, and a right suspension 36R.

The work deck 24 is provided between the pair of front wheels 30 and the pair of rear wheels 32. The work deck 24 is provided on a lower part of the vehicle body frame 26. The work deck 24 includes a housing 38, a plurality of blades 39, and a plurality of working motors 40.

The housing 38 is installed on the lower part of the vehicle body frame 26, between the pair of front wheels 30 and the pair of rear wheels 32. The housing 38 is an enclosure that opens downwardly. As shown in FIG. 1, FIG. 2, and FIG. 4, the housing 38 extends in the left-right direction from the front part 29 of the vehicle body frame 26. More specifically, the left side portion of the housing 38 is a left extending portion 38L that extends in a leftward direction from the front part 29 of the vehicle body frame 26. The right side portion of the housing 38 is a right extending portion 38R that extends in a rightward direction from the front part 29 of the vehicle body frame 26.

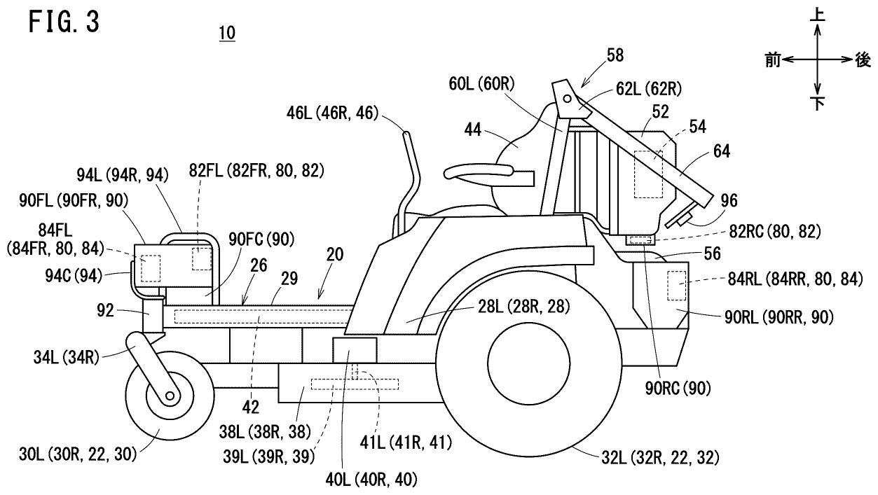

The plurality of working motors 40, for example, are a left motor 40L and a right motor 40R. The left motor 40L is installed on the left extending portion 38L. A motor shaft portion 41L (refer to FIG. 3) of the left motor 40L extends downwardly from the left motor 40L. The right motor 40R is installed on the right extending portion 38R. A motor shaft portion 41R of the right motor 40R extends downwardly from the right motor 40R. Accordingly, the plurality of working motors 40 are disposed between the pair of front wheels 30 and the pair of rear wheels 32.

The plurality of blades 39, for example, are a left blade 39L and a right blade 39R. The left blade 39L and the right blade 39R are blades having a straight line shape. The left blade 39L is supported to be capable of rotating on the motor shaft portion 41L of the left motor 40L on an inner side of the left extending portion 38L. The right blade 39R is supported to be capable of rotating on the motor shaft portion 41R of the right motor 40R on an inner side of the right extending portion 38R. Accordingly, the plurality of blades 39 are disposed between the pair of front wheels 30 and the pair of rear wheels 32. The plurality of blades 39 are covered from above by the housing 38.

Accompanying the working motors 40 being driven, each of the plurality of blades 39 rotates about the axes of the motor shaft portions 41. In FIG. 2, the dashed circles that are coaxial with the working motors 40 are rotation trajectories 43 of end parts of the blades 39. More specifically, the rotation trajectory 43L is a rotation trajectory of the left blade 39L. The rotation trajectory 43R is a rotation trajectory of the right blade 39R.

Moreover, it should be noted that the plurality of working motors 40 may be three motors (the left motor 40L, the right motor 40R, and a non-illustrated front motor). The plurality of blades 39 may be three blades (the left blade 39L, the right blade 39R, and a non-illustrated front blade). In this case, the front motor is installed on a front part of the housing 38. The front blade is a straight line shaped blade. The front blade is supported to be capable of rotating on a non-illustrated motor shaft portion that extends downwardly from the front motor on an inner side of the front part of the housing 38.

A footrest member 42, a seat 44, and a pair of control levers 46 (a left lever 46L and a right lever 46R) are provided on the vehicle body frame 26.

The footrest member 42 is disposed on the front part 29 of the vehicle body frame 26. The footrest member 42 is a rectangular plate-shaped portion that is arranged on the inner side of the front part 29 of the vehicle body frame 26. The footrest member 42 extends in a horizontal direction at the front part 29 of the vehicle body frame 26. As shown in FIG. 2, in a top view, the left extending portion 38L of the housing 38 extends in a leftward direction from the footrest member 42 and the front part 29 of the vehicle body frame 26. The right extending portion 38R of the housing 38 extends in a rightward direction from the footrest member 42 and the front part 29 of the vehicle body frame 26.

Moreover, a space more on a front side (more frontwardly) than the left extending portion 38L, and further, more on a left side (on an outer side in the leftward direction) of the left front wheel 30L is a space in which no constituent elements of the working machine 10 exist. Further, a space more on a front side (more frontwardly) than the right extending portion 38R, and further, more on a right side (on an outer side in the rightward direction) of the right front wheel 30R is a space in which no constituent elements of the working machine 10 exist. As viewed from above in FIG. 2, these spaces are regions in which the working machine 10 and the ground surface (movement surface) on which the working machine 10 travels do not overlap.

As shown in FIG. 1 to FIG. 3, the seat 44 is disposed in the intermediate part 31 and the rear part of the vehicle body frame 26. The seat 44 is disposed rearwardly of the footrest member 42, and on an inner side of the intermediate part 31 and the rear part of the vehicle body frame 26. Accordingly, in the upper/lower direction, the seat 44 is located at a higher position than the footrest member 42.

The occupant 18 of the working machine 10 gets in and gets out of the working machine 10 by straddling over the left extending portion 38L or the right extending portion 38R of the housing 38. Specifically, the occupant 18 boards the working machine 10 by straddling over the left extending portion 38L or the right extending portion 38R of the housing 38 from diagonally in front of the working machine 10 (a region in which the ground surface and the working machine 10 do not overlap when viewed from above in FIG. 2), and placing his or her feet 48 on the footrest member 42. The occupant 18 sits in the seat 44 in a state with his or her feet 48 placed on the footrest member 42. Further, the occupant 18 gets out of the working machine 10 by standing up from the seat 44, straddling over the left extending portion 38L or the right extending portion 38R of the housing 38, and placing his or her feet 48 on the ground surface diagonally in front of the working machine 10.

In FIG. 2 and FIG. 5, a getting in and getting out movement line 50 is shown, which is a movement line (trajectory) of the occupant 18 when getting in and getting out with respect to the working machine 10. The getting in and getting out movement line 50 shown in FIG. 2 and FIG. 5 is a trajectory of the occupant 18, as viewed from above, when getting in and getting out between the left front side of the working machine 10 and the working machine 10. Moreover, the occupant 18 is also capable of getting in and getting out between the right front side of the working machine 10 and the working machine 10.

The pair of control levers 46 are disposed diagonally in front of the seat 44. The left lever 46L is supported by the intermediate part 31 of the vehicle body frame 26 diagonally in front of and to the left of the seat 44. The right lever 46R is supported by the intermediate part 31 of the vehicle body frame 26 diagonally in front of and to the right of the seat 44. In a state of being seated in the seat 44, the occupant 18 is capable of operating the left lever 46L and the right lever 46R.

As shown in FIG. 1 to FIG. 4, a control box 52 is disposed rearwardly of the seat 44. The control box 52 is a housing in which a control device 54 is accommodated. The control box 52 is supported on the rear part of the vehicle body frame 26. In the upper/lower direction, a battery 56 is disposed more downwardly than the seat 44 and the control box 52. The battery 56 supplies electrical power to the control device 54, the working motors 40, and various later-described sensors 80. When electrical power is being supplied thereto from the battery 56, the control device 54 controls each of respective components of the working machine 10 such as the working motors 40, based on operations of the control levers 46 by the occupant 18 who is seated in the seat 44.

Rearwardly of the seat 44, an occupant protective mechanism 58 (protective member) is provided. The occupant protective mechanism 58 is pivotally supported on left and right support frames 60L and 60R which extend upwardly from the rear part of the vehicle body frame 26. The distance between the support frames 60L and 60R in the left-right direction is wider than the width of the seat 44 in the left-right direction. More specifically, the two support frames 60L and 60R are positioned more on outer sides than the seat 44 in the left-right direction. The occupant protective mechanism 58 includes two support portions 62L and 62R, and a safety bar 64.

The two support portions 62L and 62R are supported by the left and right support frames 60L and 60R. The distance between the support portions 62L and 62R in the left-right direction is wider than the width of the seat 44 in the left-right direction. More specifically, the two support portions 62L and 62R are positioned more on outer sides than the seat 44 in the left-right direction.

The safety bar 64 is a U-shaped frame. The safety bar 64 includes a bar main body portion 68 that extends in the left-right direction. A left side portion and a right side portion of the safety bar 64 extend from both ends of the bar main body portion 68 toward the two support portions 62L and 62R. A left end part of the safety bar 64 is pivotally supported by the support portion 62L on the left side. A right end part of the safety bar 64 is pivotally supported by the support portion 62R on the right side. Accordingly, the safety bar 64 is pivotally supported by the left and right support portions 62L and 62R. The safety bar 64 is capable of being rotated about the two support portions 62L and 62R.

Specifically, in a state in which the occupant 18 is not riding in the working machine 10, as shown in FIG. 1 to FIG. 4, the safety bar 64 is positioned rearwardly of the seat 44. More specifically, by being rotated about the left and right support portions 62L and 62R so as to move rearwardly away from the seat 44, the safety bar 64 is inclined (folded back) rearwardly from the seat 44. At this time, the bar main body portion 68 of the safety bar 64 becomes a rear end part of the occupant protective mechanism 58. The safety bar 64 is positioned rearwardly of the control box 52. In this state, the occupant 18 is capable of getting in and getting out of the working machine 10. Further, in this state, the working machine 10 can be stored, or alternatively, the working machine 10 can be transported.

The occupant 18 who is seated in the seat 44 fastens a non-illustrated seat belt that is provided in the working machine 10. In a state in which the occupant 18 is sitting in the seat 44, and the occupant protective mechanism 58 is rotated around the two support portions 62L and 62R from the state shown in FIG. 1 to FIG. 4 to the state shown in FIG. 5 to FIG. 7, the bar main body portion 68 of the safety bar 64 is positioned upwardly of the seat 44. In this state, the safety bar 64 is capable of protecting the occupant 18 at a time when the working machine 10 tips or rolls over. Moreover, it should be noted that, even when the occupant protection mechanism 58 is in the state shown in FIG. 5 to FIG. 7, the occupant 18 is capable of getting in and getting out of the working machine 10.

In the description that follows, the position of the occupant protective mechanism 58 shown in FIG. 1 to FIG. 4 will be referred to as a permissible position (second position) in which the safety bar 64 is spaced rearwardly away from the seat 44, and further, the occupant 18 is permitted to get in and get out of the working machine 10. The position of the occupant protective mechanism 58 shown in FIG. 5 to FIG. 7 will be referred to as a protective position (first position) in which the footrest member 42 and the occupant 18 who is seated in the seat 44 are protected.

As noted previously, the protective position is a position that is capable of protecting the footrest member 42 and the occupant 18 who is seated in the seat 44. Stated otherwise, the protective position is a position in which the occupant protective mechanism 58 is capable of exhibiting a protective function with respect to the occupant 18. Further, in the upper/lower direction, a highest position of the safety bar 64 in the permissible position is lower than a highest position of the safety bar 64 in the protective position. In the permissible position, the occupant 18 is capable of suitably getting in and getting out of the working machine 10, and of suitably carrying out storage of the working machine 10, transporting of the working machine 10, and the like.

As shown in FIG. 1 to FIG. 4, the working machine 10 is further equipped with the various sensors 80 (recognition units) that detect (recognize) the surrounding vicinity of the working machine 10. The various sensors 80 are LiDAR sensors 82 (recognition units) and radar sensors 84 (recognition units). The LiDAR sensors 82 and the radar sensors 84 are distance measurement sensors that detect the surrounding vicinity of the working machine 10, by means of recognition mechanisms that differ from each other.

More specifically, the LiDAR sensors 82, by emitting laser light around the vicinity of the working machine 10 and receiving reflected laser light from a working target object and surrounding objects that exist in the surrounding vicinity of the working machine 10 (second recognition mechanism), detect (recognize) the distances and the directions to the working target object and the surrounding objects, as well as the shapes of the working target object and the surrounding objects. The working target object is an object that serves as a target object of the work performed by the working machine 10. Specifically, the working target object is a lawn or grass. Further, the surrounding objects, for example, are obstacles that may become impediments to the operation of the working machine 10.

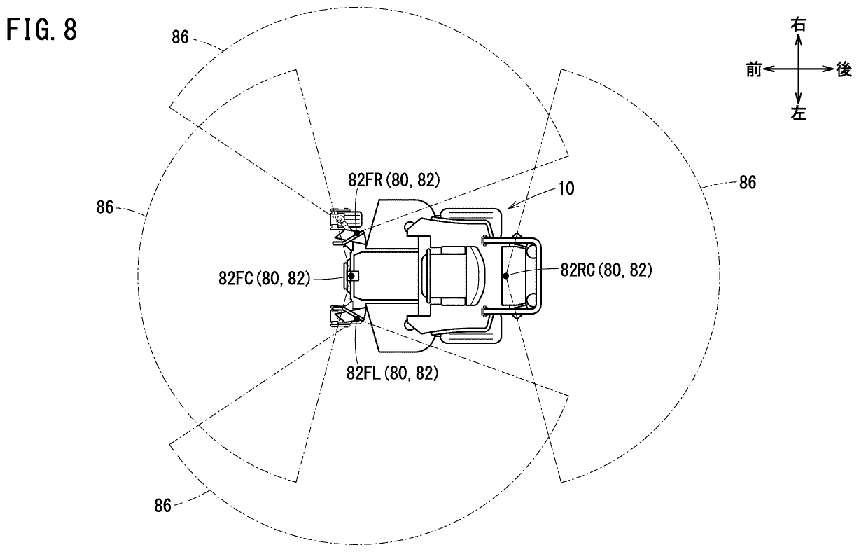

In FIG. 8, fields of view 86 of each of a plurality of LiDAR sensors 82 are illustrated. The fields of view 86 of the plurality of LiDAR sensors 82 may partially overlap. Further, in FIG. 2, centers of the fields of view 86 of each of the plurality of LiDAR sensors 82 are illustrated by dashed arrows.

The radar sensors 84, by emitting radio waves such as millimeter waves or the like around the vicinity of the working machine 10 and receiving reflected waves of the radio waves from the working target object and the surrounding objects around the vicinity of the working machine 10 (first recognition mechanism), detect (recognize) the distances and the directions to the working target object and the surrounding objects, as well as the shapes of the working target object and the surrounding objects.

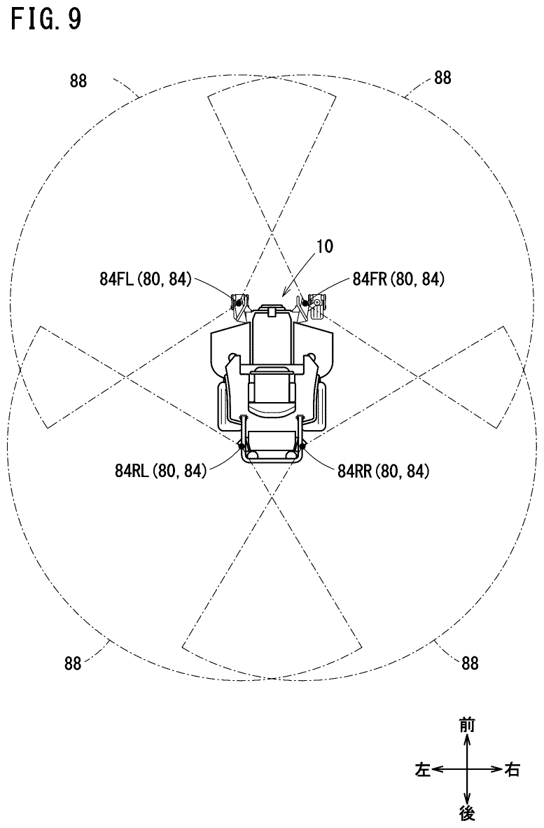

In FIG. 9, fields of view 88 of each of a plurality of radar sensors 84 are illustrated. The fields of view 88 of the plurality of radar sensors 84 may partially overlap. Further, in FIG. 2, centers of the fields of view 88 of each of the plurality of radar sensors 84 are illustrated by dashed arrows.

As shown in FIG. 8 and FIG. 9, the fields of view 86 (recognition ranges) of the LiDAR sensors 82 (refer to FIG. 8) is wider than the fields of view 88 (recognition ranges) of the radar sensors 84 (refer to FIG. 9). Further, the LiDAR sensors 82 have a higher distance measurement capability than the radar sensors 84. Furthermore, the radar sensors 84 have a higher tolerance to the recognition environment than the LiDAR sensors 82. Therefore, in the working machine 10, it is sufficient if the surrounding vicinity of the working machine 10 can be detected at least by the LiDAR sensors 82. The radar sensors 84 may detect the surrounding vicinity of the working machine 10 so as to complement the detection result of the LiDAR sensors 82. Alternatively, the working machine 10 may utilize both the LiDAR sensors 82 and the radar sensors 84, and thereby may detect the surrounding vicinity of the working machine 10. Further, as shown in FIG. 2, the LiDAR sensors 82 and the radar sensors 84 are arranged in a position that does not overlap with the work deck 24 when viewed from above. More specifically, the LiDAR sensors 82 and the radar sensors 84 are not disposed on the work deck 24.

The working machine 10 is equipped with at least one of the LiDAR sensors 82 and at least one of the radar sensors 84. In FIG. 2, a case is illustrated in which the working machine 10 is equipped with four of the LiDAR sensors 82 and four of the radar sensors 84.

Specifically, in the working machine 10, three of the LiDAR sensors 82 (front part recognition units, second front part recognition units) and two of the radar sensors 84 (front part recognition units, first front part recognition units) are arranged more on a front side than the front-rear center line 14. The three front side LiDAR sensors 82 and the two front side radar sensors 84 are positioned more rearwardly than the respective front end parts of the pair of front wheels 30 (the left front wheel 30L and the right front wheel 30R) in the front-rear direction. As shown in FIG. 3, in the upper/lower direction, the three front side LiDAR sensors 82 and the two front side radar sensors 84 are disposed more upwardly than the footrest member 42. As shown in FIG. 2, the three front side LiDAR sensors 82 and the two front side radar sensors 84 are positioned in a manner so as to avoid the getting in and getting out movement line 50 of the occupant 18 with respect to the working machine 10 (and the footrest member 42).

From among the three front side LiDAR sensors 82, one of the LiDAR sensors 82 (a front center LiDAR sensor 82FC) is positioned on the left-right center line 16. The remaining two LiDAR sensors 82 (a front left LiDAR sensor 82FL and a front right LiDAR sensor 82FR) are disposed respectively on a left side and on a right side with respect to the left-right center line 16. The two radar sensors 84 (a front left radar sensor 84FL and a front right radar sensor 84FR) are disposed respectively on the left side and the right side with respect to the left-right center line 16.

Further, in the working machine 10, one of the LiDAR sensors 82 (a rear part recognition unit) and two of the radar sensors 84 (rear part recognition units) are disposed more on a rear side than the front-rear center line 14. The rear side LiDAR sensor 82 (a rear center LiDAR sensor 82RC) is disposed on the left-right center line 16. The two radar sensors 84 (a rear left radar sensor 84RL and a rear right radar sensor 84RR) are disposed on the left and right sides, respectively, of the left-right center line 16.

A description will be given in further detail concerning the positions of the four LiDAR sensors 82 and the four radar sensors 84 in the working machine 10.

Three sensor boxes 90 (a front left sensor box 90FL, a front center sensor box 90FC, and a front right sensor box 90FR) are provided on the front side of the working machine 10. Three sensor boxes 90 (a rear left sensor box 90RL, a rear center sensor box 90RC, and a rear right sensor box 90RR) are provided on the rear side of the working machine 10. The sensors 80 are accommodated in these sensor boxes 90. The sensors 80, by being accommodated in the sensor boxes 90, are protected from the exterior of the sensor boxes 90.

The three front side sensor boxes 90 (the front left sensor box 90FL, the front center sensor box 90FC, and the front right sensor box 90FR) are provided on a front end part 92 (second portion) of the front part 29 of the vehicle body frame 26. As shown in FIG. 1 and FIG. 3, the three sensor boxes 90 are disposed, in the upper/lower direction, at a higher position than the left front wheel 30L and the right front wheel 30R. As shown in FIG. 2, the three sensor boxes 90 are disposed in closer proximity to the left-right center line 16 than both end parts (the left end part and the right end part) of the work deck 24 in the left-right direction. Moreover, the left end part of the work deck 24 is a left end part of the left extending portion 38L of the housing 38. The right end part of the work deck 24 is a right end part of the right extending portion 38R of the housing 38.

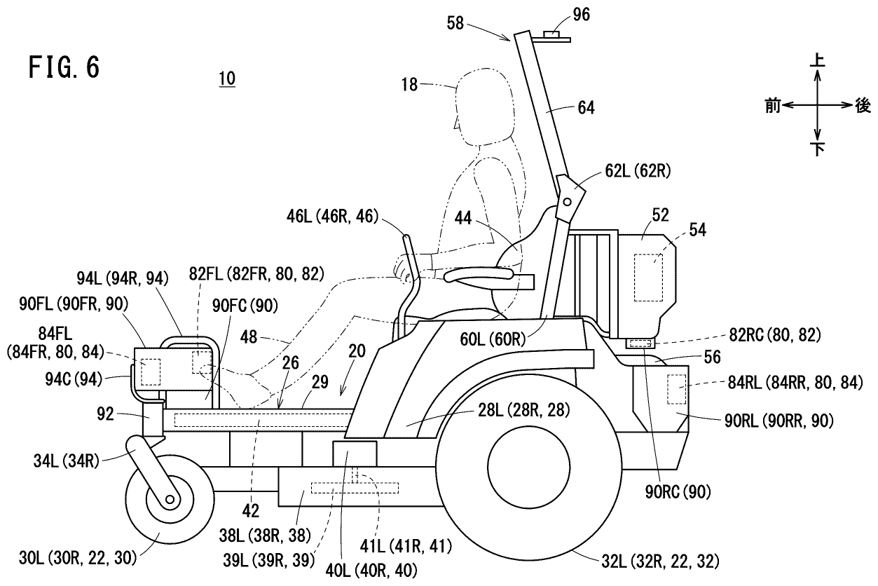

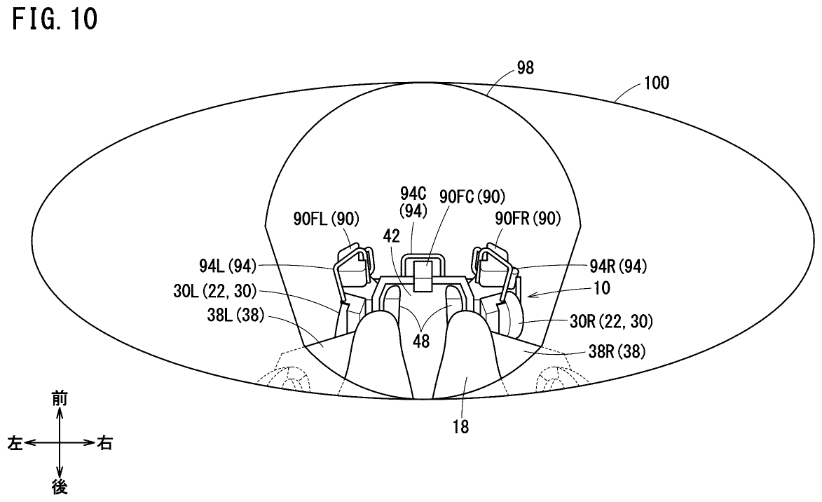

Furthermore, as shown in FIG. 10, at a time when the occupant 18 who is seated in the seat 44 (refer to FIG. 5 and FIG. 6) looks frontward, the three sensor boxes 90 are positioned so as not to overlap with the pair of front wheels 30. More specifically, the three sensor boxes 90 are disposed in a manner so that the entirety of the pair of front wheels 30 is not obscured. Moreover, in the working machine 10, the three sensor boxes 90 are arranged so that at least a portion of the left front wheel 30L, and at least a portion of the right front wheel 30R are positioned so as not to overlap with the three sensor boxes 90. Therefore, at a time when the occupant 18 who is seated in the seat 44 looks frontward, the occupant is capable of confirming at least a portion of the pair of front wheels 30, and the three sensor boxes 90.

Moreover, in FIG. 10, a central field of view 98 indicates the field of view when the occupant 18 who is seated in the seat 44 looks frontward with both eyes. Further, an elliptically shaped field of view 100 on the outer side of the field of view 98 indicates a field of view when the occupant 18 who is seated in the seat 44 looks forward with either the left eye or the right eye.

As shown in FIG. 2, the front center sensor box 90FC is disposed in a center portion of the front end part 92 of the front part 29 of the vehicle body frame 26, in a manner so as to be positioned on the left-right center line 16. In this case, the center portion of the front end part of the footrest member 42 is recessed rearwardly. The front center sensor box 90FC is disposed in the center portion of the front end part 92 of the front part 29 of the vehicle body frame 26, in a manner so as to fit into the recess of the footrest member 42.

The front center LiDAR sensor 82FC is accommodated in the front center sensor box 90FC. The front center LiDAR sensor 82FC detects the distance and the direction and the like of the working target object and the surrounding objects positioned frontwardly of the working machine 10.

The front left sensor box 90FL is disposed in a left corner part of the front end part 92 of the front part 29 of the vehicle body frame 26. More specifically, the front left sensor box 90FL is disposed more on the left side than the left-right center line 16, and further, more on the front side than the front-rear center line 14. Further, the front left sensor box 90FL is positioned, in the upper/lower direction, upwardly of the left front wheel 30L.

The front left LiDAR sensor 82FL (the left front part recognition unit) and the front left radar sensor 84FL (the left front part recognition unit) are accommodated in the front left sensor box 90FL. Accordingly, the front left LiDAR sensor 82FL and the front left radar sensor 84FL are disposed, in the upper/lower direction, upwardly of the left front wheel 30L (refer to FIG. 3). The front left LiDAR sensor 82FL is accommodated in a rear side portion of the front left sensor box 90FL. The front left radar sensor 84FL is accommodated in a front side portion of the front left sensor box 90FL. On the inner part of the front left sensor box 90FL, the front left LiDAR sensor 82FL is disposed at a higher position in the upper/lower direction than the front left radar sensor 84FL (refer to FIG. 3). Stated otherwise, on the inner part of the front left sensor box 90FL, the front left radar sensor 84FL is disposed, in the upper/lower direction, at a lower position than the front left LiDAR sensor 82FL.

The front left LiDAR sensor 82FL is accommodated in the front left sensor box 90FL, in a manner so as to recognize the left side and the left diagonally rearward region of the working machine 10. More specifically, the front left LiDAR sensor 82FL is positioned on the inner side of the front left sensor box 90FL, in a manner so that the center of the fields of view 86 (refer to FIG. 8) is directed diagonally rearward and to the left (in a leftward direction and a rearward direction) of the working machine 10. The front left LiDAR sensor 82FL detects the distance and the direction and the like of the working object and the surrounding objects positioned on the left side and in the left diagonally rearward region of the working machine 10.

The front left radar sensor 84FL is accommodated in the front left sensor box 90FL, in a manner so as to recognize the left diagonally frontward region of the working machine 10. More specifically, the front left radar sensor 84FL is positioned on the inner side of the front left sensor box 90FL, in a manner so that the center of the fields of view 88 (refer to FIG. 9) is directed diagonally frontward and to the left (in a leftward direction and a frontward direction) of the working machine 10. The front left radar sensor 84FL detects the distance and the direction and the like of the working object and the surrounding objects positioned to the left and diagonally frontward of the working machine 10.

The front right sensor box 90FR is disposed in a right corner part of the front end part 92 of the front part 29 of the vehicle body frame 26. More specifically, the front right sensor box 90FR is disposed more on the right side than the left-right center line 16, and further, more on the front side than the front-rear center line 14. The front right sensor box 90FR is disposed in closer proximity to the left-right center line 16 and more diagonally rearwardly left than the right front wheel 30R.

The front right LiDAR sensor 82FR (the right front part recognition unit) and the front right radar sensor 84FR (the right front part recognition unit) are accommodated in the front right sensor box 90FR. Accordingly, the front right LiDAR sensor 82FR and the front right radar sensor 84FR are disposed at positions that are higher than the right front wheel 30R in the upper/lower direction, and further, diagonally rearward and to the left (refer to FIG. 3). The front right LiDAR sensor 82FR is accommodated in a rear side portion of the front right sensor box 90FR. The front right radar sensor 84FR is accommodated in a front side portion of the front right sensor box 90FR. On the inner part of the front right sensor box 90FR, the front right LiDAR sensor 82FR is disposed, in the upper/lower direction, at a higher position than the front right radar sensor 84FR (refer to FIG. 3). Stated otherwise, on the inner part of the front right sensor box 90FR, the front right radar sensor 84FR is disposed, in the upper/lower direction, at a lower position than the front right LiDAR sensor 82FR.

The front right LiDAR sensor 82FR is accommodated in the front right sensor box 90FR, in a manner so as to recognize the right side and the right diagonally rearward region of the working machine 10. More specifically, the front right LiDAR sensor 82FR is positioned on the inner side of the front right sensor box 90FR, in a manner so that the center of the fields of view 86 (refer to FIG. 8) is directed diagonally rearward and to the right (in a rightward direction and a rearward direction) of the working machine 10. The front right LiDAR sensor 82FR detects the distance and the direction and the like of the working object and the surrounding objects positioned on the right side and the diagonally rearward region of the working machine 10.

The front right radar sensor 84FR is accommodated in the front right sensor box 90FR, in a manner so as to recognize the right diagonally frontward region of the working machine 10. More specifically, the front right radar sensor 84FR is positioned on the inner side of the front right sensor box 90FR, in a manner so that the center of the fields of view 88 (refer to FIG. 9) is directed diagonally frontward and to the right (in a rightward direction and a frontward direction) of the working machine 10. The front right radar sensor 84FR detects the distance and the direction and the like of the working object and the surrounding objects positioned to the right and diagonally frontward of the working machine 10.

As shown in FIG. 1 and FIG. 2, guard members 94 (guard) are disposed in close proximity to each of the three sensor boxes 90 on the front side. Each of the plurality of guard members 94 (a center guard member 94C, a left guard member 94L, and a right guard member 94R) is a pipe-shaped guard member for the purpose of protecting the sensor boxes 90 and the sensors 80 that are accommodated in the sensor boxes 90.

The center guard member 94C is disposed frontwardly of the front center sensor box 90FC in the front-rear direction. Both ends of the center guard member 94C are fixed to the front end part 92 of the front part 29 of the vehicle body frame 26.

The left guard member 94L is disposed in close proximity to the front left sensor box 90FL, in a manner so as to straddle over the front left sensor box 90FL. A front end part of the left guard member 94L is positioned, in the front-rear direction, more frontwardly than the front left sensor box 90FL. A rear end part of the left guard member 94L is positioned, in the front-rear direction, rearwardly of the front left sensor box 90FL. Both ends of the left guard member 94L are fixed to the left corner parts of the front end part 92 of the front part 29 of the vehicle body frame 26.

The right guard member 94R is disposed in close proximity to the front right sensor box 90FR, in a manner so as to straddle over the front right sensor box 90FR. A front end part of the right guard member 94R is positioned, in the front-rear direction, more frontwardly than the front right sensor box 90FR. A rear end part of the right guard member 94R is positioned, in the front-rear direction, rearwardly of the front right sensor box 90FR. Both ends of the right guard member 94R are fixed to the right corner parts of the front end part 92 of the front part 29 of the vehicle body frame 26.

As shown in FIG. 3 and FIG. 4, the three rear side sensor boxes 90 (the rear left sensor box 90RL, the rear center sensor box 90RC, and the rear right sensor box 90RR) are provided in the battery 56 or in the control box 52. The rear center sensor box 90RC is disposed in the center portion of the lower end part of the control box 52. The rear center sensor box 90RC is disposed rearwardly of the left rear wheel 32L and the right rear wheel 32R, and in the upper/lower direction, is disposed at a position that is higher than the left rear wheel 32L and the right rear wheel 32R. The rear left sensor box 90RL is disposed on a left rear corner part of the battery 56. The rear right sensor box 90RR is disposed on a right rear corner part of the battery 56. The rear left sensor box 90RL and the rear right sensor box 90RR are disposed rearwardly of the left rear wheel 32L and the right rear wheel 32R, and in the upper/lower direction, are disposed at a position that is higher than the centers of the left rear wheel 32L and the right rear wheel 32R. The rear center sensor box 90RC is disposed, in the upper/lower direction, at a higher position than the rear left sensor box 90RL and the rear right sensor box 90RR.

As shown in FIG. 2, the rear center sensor box 90RC is disposed in the center portion of the lower end part of the control box 52, in a manner so as to be positioned on the left-right center line 16. As shown in FIG. 3, the rear center sensor box 90RC is disposed, in the upper/lower direction, at a higher position than the three front side sensor boxes 90 (the front left sensor box 90FL, the front center sensor box 90FC, and the front right sensor box 90FR). The rear center LiDAR sensor 82RC is accommodated in the rear center sensor box 90RC. Accordingly, the rear center LiDAR sensor 82RC is disposed, in the upper/lower direction, at a higher position than the three front LiDAR sensors 82 and the two front radar sensors 84. The rear center LiDAR sensor 82RC detects the distance and the direction and the like of the working target object and the surrounding objects positioned rearwardly of the working machine 10. More specifically, the rear center LiDAR sensor 82RC is accommodated in the rear center sensor box 90RC, in a manner so that the center of the fields of view 86 (refer to FIG. 8) is directed in the rearward direction.

The rear left sensor box 90RL is disposed more on the left side than the left-right center line 16, and further, more on the rear side than the front-rear center line 14. The rear left radar sensor 84RL (the left rear recognition unit) is accommodated in the rear left sensor box 90RL. The rear left radar sensor 84RL is accommodated in the rear left sensor box 90RL, in a manner so as to recognize the left diagonally rearward region of the working machine 10. More specifically, the rear left radar sensor 84RL is positioned on the inner side of the rear left sensor box 90RL, in a manner so that the center of the fields of view 88 (refer to FIG. 9) is directed diagonally rearward and to the left (in a leftward direction and a rearward direction) of the working machine 10. The rear left radar sensor 84RL detects the distance and the direction and the like of the working object and the surrounding objects positioned to the left and diagonally rearward of the working machine 10.

The rear right sensor box 90RR is disposed more on the right side than the left-right center line 16, and further, more on the rear side than the front-rear center line 14. The rear right radar sensor 84RR (the right rear recognition unit) is accommodated in the front right sensor box 90FR. The front right radar sensor 84FR is accommodated in the rear right sensor box 90RR, in a manner so that the center of the fields of view 88 (refer FIG. 9) is recognized as a region diagonally rearward and to the right of the working machine 10. More specifically, the rear right radar sensor 84RR is disposed on the inner side of the rear right sensor box 90RR, in a manner so as to be directed diagonally rearward and to the right (in a rightward direction and a rearward direction) of the working machine 10. The rear right radar sensor 84RR detects the distance and the direction and the like of the working object and the surrounding objects positioned to the right and diagonally rearward of the working machine 10.

The working machine 10 is further equipped with two GNSS sensors 96. The two GNSS sensors 96 are installed on the safety bar 64. The two GNSS sensors 96 are installed at a predetermined interval on the bar main body portion 68 of the safety bar 64. The two GNSS sensors 96 receive signals emitted from non-illustrated GNSS satellites. The control device 54, based on the signals received by the two GNSS sensors 96, specifies the current position of the working machine 10.

The two GNSS sensors 96, at a time when the safety bar 64 is in the permissible position (refer to FIG. 1 to FIG. 4), are positioned rearwardly of the control box 52. Further, at a time when the safety bar 64 is in the protective position (refer to FIG. 5 to FIG. 7), the two GNSS sensors 96 are positioned upwardly of the seat 44. The two GNSS sensors 96, at a time when the safety bar 64 is in the protective position, are capable of satisfactorily receiving signals from the GNSS satellites.

Next, a description will be given concerning operations of the working machine 10 according to the present embodiment. In this instance, a description will be given of a case in which the working machine 10 travels in an occupied manner and a case in which the working machine 10 travels in an unmanned manner.

At first, a description will be given concerning a case in which the working machine 10 undergoes manned traveling.

At a time when the occupant protective mechanism 58 is in the permissible position (refer to FIG. 1 to FIG. 4), the occupant 18 (refer to FIG. 5 to FIG. 7), for example, straddles over the left extending portion 38L of the housing 38 from the diagonally left front side of the working machine 10 along the getting in and getting out movement line 50, and places his or her feet 48 on the footrest member 42. Consequently, the occupant 18 boards the working machine 10. The occupant 18 sits in the seat 44 in a state with his or her feet 48 placed on the footrest member 42. At this time, when the occupant 18 who is seated in the seat 44 looks frontward, the three sensor boxes 90 are positioned in a manner so as not to overlap with the pair of front wheels 30 (refer to FIG. 10). Consequently, the occupant 18 is capable of visually viewing the pair of front wheels 30, and the ground surface on which the front wheels 30 are rolling.

Next, the occupant 18 causes the safety bar 64 to be rotated frontwardly about the two support portions 62L and 62R. Consequently, the occupant protective mechanism 58 moves from the permissible position (refer to FIG. 1 to FIG. 4) to the protective position (refer to FIG. 5 to FIG. 7), and in the upper/lower direction, the bar main body portion 68 of the safety bar 64 is positioned more upwardly than the seat 44. As a result, the occupant 18 who is seated in the seat 44 becomes capable of being appropriately protected at a time when the working machine 10 tips or rolls over. Further, in the upper/lower direction, the two GNSS sensors 96 can be positioned more upwardly than the seat 44.

Next, the occupant 18 causes the working machine 10 to be started by operating a non-illustrated ON switch. The control device 54, based on the operation of the ON switch by the occupant 18, starts the supply of electrical power from the battery 56 to each of the respective components of the working machine 10.

Consequently, the two GNSS sensors 96 are powered by the supply of electrical power from the battery 56, and start to receive signals from the GNSS satellites. The two GNSS sensors 96 output the signals that have been successively received to the control device 54. Based on the signals received from the two GNSS sensors 96, the control device 54 specifies the current position of the working machine 10.

Further, each of the plurality of LiDAR sensors 82 is driven by the supply of electrical power from the battery 56, and sequentially detects the distance and the direction and the like of the working target object and the surrounding objects that exist within the fields of view 86 (refer to FIG. 8). Each of the plurality of radar sensors 84 is driven by the supply of electrical power from the battery 56, and sequentially detects the distance and the direction and the like of the working target object and the surrounding objects that exist within the fields of view 88 (refer to FIG. 9). The respective detection results of the plurality of LiDAR sensors 82 and the plurality of radar sensors 84 are output sequentially to the control device 54.

Accompanying the operation of the control levers 46 by the occupant 18, the working machine 10 moves forward, moves rearward, stops, or turns. More specifically, in accordance with the operation of the control levers 46 by the occupant 18, the control device 54, by controlling the driving of the left traveling motor and the right traveling motor, causes the working machine 10 to move forward, move rearward, stop, or turn. Moreover, it should be noted that the concepts of pivotal turning and ultra-pivotal turning are included within the meaning of the term turning.

The control device 54 causes the work deck 24 to be raised and lowered in accordance with the operations of the control levers 46 by the occupant 18. Further, the control device 54, in accordance with the operations of the control levers 46 by the occupant 18, and by controlling the driving of the two working motors 40 provided on the work deck 24, the two blades 39 are caused to undergo rotation or be stopped. Consequently, the working machine 10 is capable of carrying out the grass cutting operation in the working region.

Further, when there is a possibility, based on the respective detection results of the plurality of LiDAR sensors 82 and the plurality of radar sensors 84, that the working machine 10 may collide with objects in the surrounding vicinity while the working machine 10 is traveling, the control device 54 causes the driving of the left traveling motor and the right traveling motor to be stopped, and thereby causes the traveling of the working machine 10 to be stopped.

When the lawn mowing operation in the working region is completed, the occupant 18 causes the traveling of the working machine 10 to be stopped, and thereafter, operates a non-illustrated OFF switch. Consequently, based on the operation of the OFF switch by the occupant 18, the control device 54 stops the supply of electrical power from the battery 56 to each of the respective components of the working machine 10. As a result, the working machine 10 stops operating.

Next, the occupant 18 causes the safety bar 64 to be rotated rearwardly, and causes the occupant protective mechanism 58 to be moved from the protective position to the permissible position. Thereafter, the occupant 18 stands up from the seat 44, straddles over the extending portion of the work deck 24 from the footrest member 42 along the getting in and getting out movement line 50, and by moving onto the ground surface that is diagonally forward and to the left of the footrest member 42, dismounts from the working machine 10.

Next, a description will be given concerning a case in which the working machine 10 undergoes unmanned traveling. In such unmanned traveling, a teaching process and a playback process are carried out. In the teaching process, the travel route of the working machine 10 in the working region that serves as a target of the lawn mowing operation is memorized and stored in the working machine 10 by means of the above-described manned traveling. In the playback process, in a state in which the occupant 18 is not riding on the working machine 10, the working machine 10 performs the lawn mowing operation while traveling along the travel route that was stored in the teaching process. More specifically, in the playback process, the working machine 10 carries out autonomous traveling and autonomous operation.

At first, in the teaching process, in the working region that serves as the target of the lawn mowing operation, the aforementioned manned traveling is carried out in a state in which the operator is riding on the working machine 10. At this time, the control device 54 stores in a non-illustrated storage device the path (the travel route) that is traveled by the working machine 10.

Next, in the playback process, the control device 54, by controlling the driving of the left traveling motor and the right traveling motor in accordance with the travel route that was stored in the storage device, causes the working machine 10 to travel autonomously within the working region. The control device 54, by controlling the driving of the two working motors 40 and thereby causing the two blades 39 to be rotated, carries out the lawn mowing operation in an autonomous manner.

Even during the playback process, the plurality of LiDAR sensors 82 and the plurality of radar sensors 84 sequentially detect the distance and the direction and the like of the working target object and the surrounding objects that exist within the fields of view 86 and 88 (refer to FIG. 8 and FIG. 9). When there is a possibility, based on the respective detection results of the plurality of LiDAR sensors 82 and the plurality of radar sensors 84, that the working machine 10 may collide with objects in the surrounding vicinity while the working machine 10 is undergoing unmanned traveling, the control device 54 causes the driving of the left traveling motor and the right traveling motor to be stopped, and thereby causes the traveling of the working machine 10 to be stopped.

Next, a description will be given concerning the advantageous effects of the present embodiment.

As shown in FIG. 2, the working machine 10 is equipped with the plurality of sensors 80 (recognition units) that recognize the surrounding vicinity of the working machine 10. In accordance with this feature, it is possible to easily recognize the situation of the surrounding vicinity around the working machine 10 (for example, the working region of the working machine 10). Accordingly, based on the detection result (recognition result) of each of the sensors 80, at least one from among either one of autonomous traveling and autonomous operation of the working machine 10 becomes possible.

Since the plurality of LiDAR sensors 82 and the plurality of radar sensors 84 are disposed frontwardly with respect to the front-rear center line 14, it is possible to effectively recognize the situation of the surrounding vicinity of the working machine 10 (for example, more frontwardly than the front-rear center line 14). As a result, blind spots frontwardly of the working machine 10 can be made fewer.

The plurality of LiDAR sensors 82 and the plurality of radar sensors 84 are positioned in closer proximity to the left-right center line 16 than the end parts (the left end part and the right end part) of the housing 38 of the work deck 24 in the left-right direction. In accordance with this feature, it is possible to reduce the contact between the working target object and the surrounding objects that exist more on outer sides in the left-right direction than the work deck 24, and the plurality of LiDAR sensors 82 and the plurality of radar sensors 84.

The plurality of radar sensors 84 recognize the surrounding vicinity of the working machine 10 by a first recognition mechanism (distance measurement by means of radio waves). The plurality of LiDAR sensors 82 are disposed in the vicinity of the plurality of radar sensors 84, and recognize the surrounding vicinity of the working machine 10 by a second recognition mechanism (distance measurement by means of laser light) that differs from the first recognition mechanism. In accordance with this feature, based on the recognition mechanisms that differ from each other, it is possible to effectively recognize the situation of the surrounding vicinity of the working machine 10.

As shown in FIG. 3 and FIG. 4, the LiDAR sensors 82, which have wider fields of view 86 (refer to FIG. 8) than the fields of view 88 (refer to FIG. 9) of the radar sensors 84, are disposed at a higher position in the upper/lower direction than the radar sensors 84. In accordance with this feature, a larger space is capable of being defined as the fields of view 86.

The LiDAR sensors 82, which have a higher distance measurement capability than the radar sensors 84, are disposed at a higher position in the upper/lower direction than the radar sensors 84. In accordance with this feature, it is possible to improve the distance measurement capability with respect to the larger space.

The radar sensors 84, which have a higher tolerance to the recognition environment than the LiDAR sensors 82, are disposed at a lower position in the upper/lower direction than the LiDAR sensors 82. In accordance with this feature, it is possible to effectively recognize foreign objects and the like that exist on the ground surface in front of the direction of travel of the working machine 10, and further, that have a possibility of colliding with the working machine 10.

Since the radar sensors 84 on the front side, which have a higher tolerance to the recognition environment than the LiDAR sensors 82 on the front side, are disposed more frontwardly than the LiDAR sensors 82, it is possible to effectively recognize foreign objects and the like that exist on the ground surface in front of the direction of travel of the working machine 10, and further, that have a possibility of colliding with the working machine 10.

As shown in FIG. 2, the pair of front wheels 30 are disposed frontwardly with respect to the front-rear center line 14, and in the front-rear direction, the plurality of LiDAR sensors 82 on the front side and the plurality of radar sensors 84 on the front side are disposed more rearwardly than the front end part of the front wheels 30. In accordance with this feature, it is possible to reduce the risk of foreign objects or the like colliding with the plurality of LiDAR sensors 82 and the plurality of radar sensors 84 while the working machine 10 is moving forward.

The front left LiDAR sensor 82FL and the front left radar sensor 84FL are disposed, in the upper/lower direction, upwardly of the left front wheel 30L (refer to FIG. 3), and further, as viewed from above in FIG. 2, are positioned so as to overlap with the left front wheel 30L. In accordance with this feature, while the working machine 10 is moving forward, it is possible to reduce the risk of foreign objects and the like colliding with the front left LiDAR sensor 82FL and the front left radar sensor 84FL. Further, it is possible to effectively recognize foreign objects and the like that exist on the ground surface in front of the direction of travel of the working machine 10, and further, that have a possibility of colliding with the working machine 10.

As shown in FIG. 10, when viewed from the occupant 18 who is seated in the seat 44 with his or her feet on the footrest member 42, the three sensor boxes 90 in which the plurality of LiDAR sensors 82 and the plurality of radar sensors 84 are accommodated are positioned at positions that do not overlap with at least a portion of the pair of front wheels 30. More specifically, the three sensor boxes 90 (the plurality of LiDAR sensors 82 and the plurality of radar sensors 84) are disposed in a manner so that the entirety of the pair of front wheels 30 is not obscured. In accordance with this feature, the seated occupant 18 is capable of visually viewing at least a portion of the pair of front wheels 30, the state of the ground surface on which the pair of front wheels 30 roll, and the three sensor boxes 90 (the plurality of LiDAR sensors 82 and the plurality of radar sensors 84).

As shown in FIG. 1 and FIG. 2, the plurality of guard members 94 are positioned more frontwardly than the front end parts of the plurality of LiDAR sensors 82 and the plurality of radar sensors 84 in the front-rear direction, and further, protect the plurality of LiDAR sensors 82 and the plurality of radar sensors 84. In accordance with this feature, the plurality of LiDAR sensors 82 and the plurality of radar sensors 84 can be effectively protected from foreign objects and the like that exist on the ground surface frontwardly in the direction of travel of the working machine 10, and further, that have a possibility of colliding with the plurality of LiDAR sensors 82 and the plurality of radar sensors 84.

As shown in FIG. 3, in the upper/lower direction, the plurality of LiDAR sensors 82 and the plurality of radar sensors 84 are disposed at a higher position than the footrest member 42. In accordance with this feature, contact of the plurality of LiDAR sensors 82 and the plurality of radar sensors 84 with the feet 48 of the occupant 18 (refer to FIG. 5 to FIG. 7) can be reduced. Further, it is possible to reduce the possibility of the plurality of LiDAR sensors 82 and the plurality of radar sensors 84 coming into contact and getting dirty with the feet 48 of the occupant 18.

As shown in FIG. 2, the plurality of LiDAR sensors 82 and the plurality of radar sensors 84 are positioned in a position that avoids the getting in and getting out movement line 50 of the occupant 18 (see FIG. 5 to FIG. 7) between the footrest member 42 and the exterior of the working machine 10. In accordance with this feature, at a time when the occupant 18 is getting in and getting out with respect to the footrest member 42, it is possible to reduce the possibility of the plurality of LiDAR sensors 82 and the plurality of radar sensors 84 coming into contact with the feet 48 of the occupant. Further, it is possible to effectively reduce the possibility of the plurality of LiDAR sensors 82 and the plurality of radar sensors 84 coming into contact and getting dirty with the feet 48 of the occupant 18.

The housing 38 of the work deck 24 includes the left extending portion 38L and the right extending portion 38R that extend more outwardly in the left-right direction than the footrest member 42. The region more frontwardly than the left extending portion 38L and the right extending portion 38R, and further, on outer sides in the left and right direction of the plurality of LiDAR sensors 82 and the plurality of radar sensors 84, when viewed from above in FIG. 2, is a region in which the working machine 10 does not overlap with the ground surface on which the working machine 10 moves. In accordance with this feature, without placing his or her feet 48 on the left extending portion 38L and the right extending portion 38R, the plurality of LiDAR sensors 82, and the plurality of radar sensors 84, the occupant 18 is capable of getting in and getting out between the region in which the ground surface and the working machine 10 do not overlap, and the footrest member 42.

The front left LiDAR sensor 82FL and the front right LiDAR sensor 82FR are positioned in a manner so that the center of the fields of view 86 (refer to FIG. 8) is directed in the left-right direction and the rearward direction of the working machine 10. In accordance with this feature, even in the case that the front left LiDAR sensor 82FL and the front right LiDAR sensor 82FR are disposed in the front part region (on the front side) of the working machine 10, it is possible to recognize the left-right direction and the rearward direction of the working machine 10.

The plurality of LiDAR sensors 82 and the plurality of radar sensors 84 are positioned in closer proximity to the left-right center line 16 than the left end part of the left front wheel 30L, or alternatively, in closer proximity to the left-right center line 16 than the right end part of the right front wheel 30R. In accordance with this feature, it is possible to reduce the contact between the working target object and the surrounding objects that exist more on the outer sides in the left-right direction of the working machine 10 than the left front wheel 30L and the right front wheel 30R, and the plurality of LiDAR sensors 82 and the plurality of radar sensors 84.

The rear center LiDAR sensor 82RC, the rear left radar sensor 84RL, and the rear right radar sensor 84RR are positioned rearwardly with respect to the front-rear center line 14. In accordance with this feature, it is possible to effectively recognize the situation of the surrounding vicinity (for example, more rearwardly than the front-rear center line 14) of the working machine 10.

As shown in FIG. 3, the rear center LiDAR sensor 82RC is disposed at a higher position in the upper/lower direction, in comparison with the plurality of LiDAR sensors 82 on the front side, and the plurality of radar sensors 84 on the front side and the rear side. In accordance with this feature, a larger space is capable of being defined as the fields of view 86.

A smaller number of the rear center LiDAR sensors 82RC are disposed at a higher position in the upper/lower direction, in comparison with the plurality of LiDAR sensors 82 on the front side, and the plurality of radar sensors 84 on the front side and the rear side. In accordance with this feature, even if the number of the rear center LiDAR sensors 82RC is small, it is possible to widen the fields of view 86 of the rear center LiDAR sensors 82RC.

As shown in FIG. 2, the plurality of LiDAR sensors 82 and the plurality of radar sensors 84 are disposed on the left side and the right side with respect to the left-right center line 16. In accordance with this feature, it is possible to effectively recognize the situation of the surrounding vicinity (for example, more on the left side and the right side than the left-right center line 16) of the working machine 10.

The plurality of LiDAR sensors 82 and the plurality of radar sensors 84 on the left side are disposed in closer proximity to the left-right center line 16 than the left end part of the work deck 24. Further, the plurality of LiDAR sensors 82 and the plurality of radar sensors 84 on the right side are disposed in closer proximity to the left-right center line 16 than the right end part of the work deck 24. In accordance with this feature, it is possible to reduce the contact between the working target object and the surrounding objects that exist more on outer sides in the left-right direction than the work deck 24, and the left and right plurality of LiDAR sensors 82 and the left and right plurality of radar sensors 84.

The plurality of LiDAR sensors 82 and the plurality of radar sensors 84 on the left side are disposed in closer proximity to the left-right center line 16 than the left end part of the left vehicle wheels 22. Further, the plurality of LiDAR sensors 82 and the plurality of radar sensors 84 on the right side are disposed in closer proximity to the left-right center line 16 than the right end part of the right vehicle wheels 22. In accordance with this feature, it is possible to effectively reduce the contact between the working target object and the surrounding objects that exist more on outer sides in the left-right direction of the working machine 10 than the left and right vehicle wheels 22, and the left and right plurality of LiDAR sensors 82 and the left and right plurality of radar sensors 84.

On the left side of the working machine 10, there are disposed the front left LiDAR sensor 82FL and the front left radar sensor 84FL, which are disposed frontwardly with respect to the front-rear center line 14, and the rear left radar sensor 84RL, which is disposed rearwardly with respect to the front-rear center line 14. On the right side of the working machine 10, there are disposed the front right LiDAR sensor 82FR and the front right radar sensor 84FR, which are disposed frontwardly with respect to the front-rear center line 14, and the rear right radar sensor 84RR, which is disposed rearwardly with respect to the front-rear center line 14. In accordance with this feature, it is possible to more effectively recognize the situation of the surrounding vicinity of the working machine 10.

The occupant protective mechanism 58 is capable of moving between the protective position (the first position) (refer to FIG. 5 to FIG. 7) that protects the occupant 18 who is seated in the seat 44 with his or her feet on the footrest member 42, and the permissible position (the second position) (refer to FIG. 1 to FIG. 4) in which the safety bar 64 is separated apart rearwardly with respect to the seat 44, and further, permits the occupant 18 to get in and out with respect to the seat 44. The rear left radar sensor 84RL and the rear right radar sensor 84RR are disposed more frontwardly than the rear end part of the occupant protective mechanism 58 that is positioned in the permissible position. At a time when the working machine 10 is not in use and further is stopped, since the occupant 18 is not seated in the seat 44, the occupant protective mechanism 58 is positioned in the permissible position. In accordance with this feature, while the working machine 10 is stopped, the occupant protective mechanism 58 may receive an external force from rearwardly of the working machine 10. As a result, while the working machine 10 is stopped, it is possible to suppress the external force from rearwardly of the working machine 10 from being applied to the rear left radar sensor 84RL and the rear right radar sensor 84RR. Further, since the highest position of the safety bar 64 in the permissible position is lower than the highest position of the safety bar 64 in the protective position, it is possible for the occupant 18 to conveniently get in and get out with respect to the working machine 10, suitably carry out storage of the working machine 10, transport the working machine 10, and the like.

The plurality of LiDAR sensors 82 and the plurality of radar sensors 84 are arranged in a position that does not overlap with the work deck 24 when viewed from above in FIG. 2. In accordance with this feature, it is possible to suppress a decrease in the recognition accuracy of the plurality of LiDAR sensors 82 and the plurality of radar sensors 84 and a progression in the deterioration of the plurality of LiDAR sensors 82 and the plurality of radar sensors 84 that are caused by the operation and work vibrations of the work deck 24, as well as flying objects and the like accompanying the operation of the work deck 24.

As shown in FIG. 1, the working machine 10 is equipped with the machine body 20, and the machine body 20 includes the vehicle body frame 26. The vehicle body frame 26 constitutes a framework of the entire working machine 10. The work deck 24 is fixed to the front part 29 of the vehicle body frame 26. The plurality of LiDAR sensors 82 and the plurality of radar sensors 84 are fixed to the front end part 92 of the front part 29 of the vehicle body frame 26. In accordance with this feature, a position of the vehicle body frame 26 to which the work deck 24 is fixed is different from a position of the vehicle body frame 26 to which the plurality of LiDAR sensors 82 and the plurality of radar sensors 84 are fixed. As a result, transmission of the operation and working vibrations of the work deck 24 to the plurality of LiDAR sensors 82 and the plurality of radar sensors 84 can be effectively suppressed.

Next, a description will be given concerning exemplary modifications (first and second exemplary modifications) of the working machine 10 according to the present embodiment. Moreover, in the first exemplary modification and the second exemplary modification, concerning the same constituent elements as those in the working machine 10 according to the present embodiment (refer to FIG. 1 to FIG. 10), these elements are designated by the same reference numerals and detailed description of such features will be omitted.

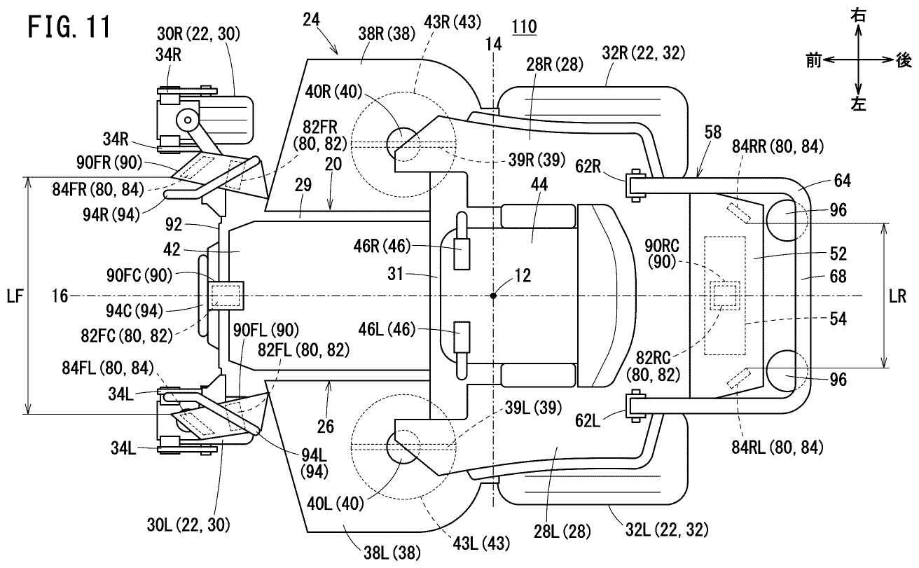

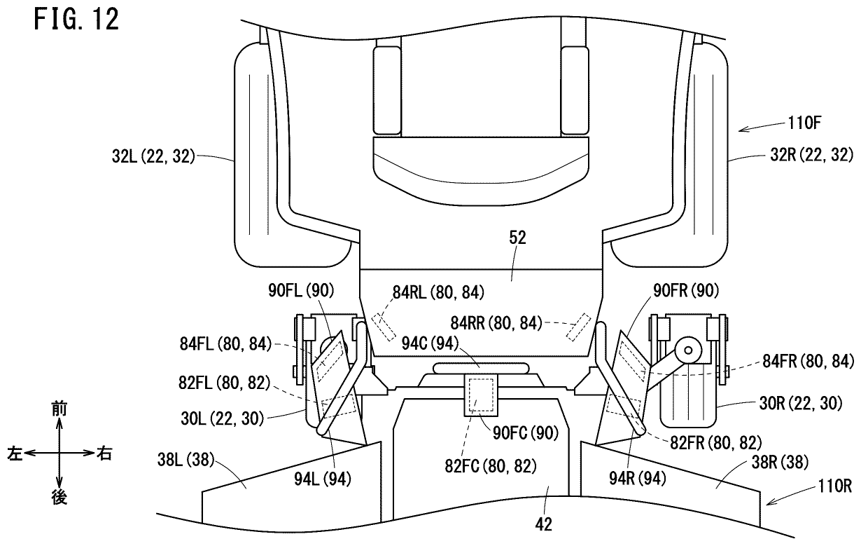

FIG. 11 and FIG. 12 show a working machine 110 according to the first exemplary modification. Among these figures, FIG. 12 is a plan view showing identical working machines 110 (a frontwardly located working machine 110F and a rearwardly located working machine 110R) that are aligned in a front-to-rear direction. In FIG. 12, a case is illustrated in which the plurality of working machines 110 are disposed in close proximity to each other from the front to the rear, at a time when the working machines 110 are stored or transported. Moreover, in FIG. 12, to facilitate the description, the safety bar 64 and the GNSS sensors 96 are omitted from illustration.

In the working machine 110 according to the first exemplary modification, when viewed from above as in FIG. 11 and FIG. 12, the rear left radar sensor 84RL is disposed in a manner so that the distance between the rear left radar sensor 84RL and the left-right center line 16 in the left-right direction is smaller than the distance between the front left radar sensor 84FL and the front left LiDAR sensor 82FL and the left-right center line 16 in the left-right direction. Further, the rear right radar sensor 84RR is positioned in a manner so that the distance between the rear right radar sensor 84RR and the left-right center line 16 in the left-right direction is smaller than the distance between the front right radar sensor 84FR and the front right LiDAR sensor 82FR and the left-right center line 16 in the left-right direction.

More specifically, the rear left radar sensor 84RL is disposed in closer proximity to the left-right center line 16 than the front left radar sensor 84FL and the front left LiDAR sensor 82FL. The rear right radar sensor 84RR is positioned in closer proximity to the left-right center line 16 than the front right radar sensor 84FR and the front right LiDAR sensor 82FR. Accordingly, the distance LR between the rear left radar sensor 84RL and the rear right radar sensor 84RR in the left-right direction is smaller than the distance LF between the front left radar sensor 84FL and the front left LiDAR sensor 82FL and the front right radar sensor 84FR and the front right LiDAR sensor 82FR in the left-right direction (LF>LR). Stated otherwise, the distance LF between the front left radar sensor 84FL and the front left LiDAR sensor 82FL and the front right radar sensor 84FR and the front right LiDAR sensor 82FR in the left-right direction is greater than the distance LR between the rear left radar sensor 84RL and the rear right radar sensor 84RR in the left-right direction.

Further, at a time when the occupant protective mechanism 58 is in the permissible position, the rear left radar sensor 84RL and the rear right radar sensor 84RR are disposed on an inner side of the safety bar 64. In this case, the rear left radar sensor 84RL may be installed, for example, on a left rear corner part of the control box 52. The rear right radar sensor 84RR may be installed, for example, on a right rear corner part of the control box 52.

Next, a description will be given concerning the advantageous effects of the first exemplary modification.

In the first exemplary modification, the distance LR between the rear left radar sensor 84RL and the rear right radar sensor 84RR in the left-right direction, and the distance LF between the front left radar sensor 84FL and the front left LiDAR sensor 82FL and the front right radar sensor 84FR and the front right LiDAR sensor 82FR in the left-right direction are different from each other. In accordance with this feature, as shown in FIG. 12, at a time when a plurality of the working machines 110 are aligned in a front-to-rear manner, it is possible to prevent interference from occurring between the rear left radar sensor 84RL and the rear right radar sensor 84RR of the frontwardly located working machine 110F, and the front left radar sensor 84FL, the front left LiDAR sensor 82FL, the front right radar sensor 84FR, and the front right LiDAR sensor 82FR of the rearwardly located working machine 110R.

Further, the distance LF between the front left radar sensor 84FL and the front right radar sensor 84FR in the left-right direction is greater than the distance LR between the rear left radar sensor 84RL and the rear right radar sensor 84RR in the left-right direction. In accordance with this feature, each of the fields of view 88 of the front left radar sensor 84FL and the front right radar sensor 84FR can be made wider than the fields of view 88 of the rear left radar sensor 84RL and the rear right radar sensor 84RR. As a result, in the working machine 110 that moves frontwardly at a higher frequency than rearwardly, and further, in which the forward speed thereof is faster than the rearward speed, the fields of view 88 in the frontward direction of the working machine 110 can be easily made wider.

Furthermore, at a time when the occupant protective mechanism 58 is in the permissible position, since the rear left radar sensor 84RL and the rear right radar sensor 84RR are positioned on the inner side of the safety bar 64, external forces from rearwardly of the working machine 110 can be received by the safety bar 64. In accordance with this feature, the rear left radar sensor 84RL and the rear right radar sensor 84RR can be appropriately protected from external forces from rearwardly of the working machine 110.

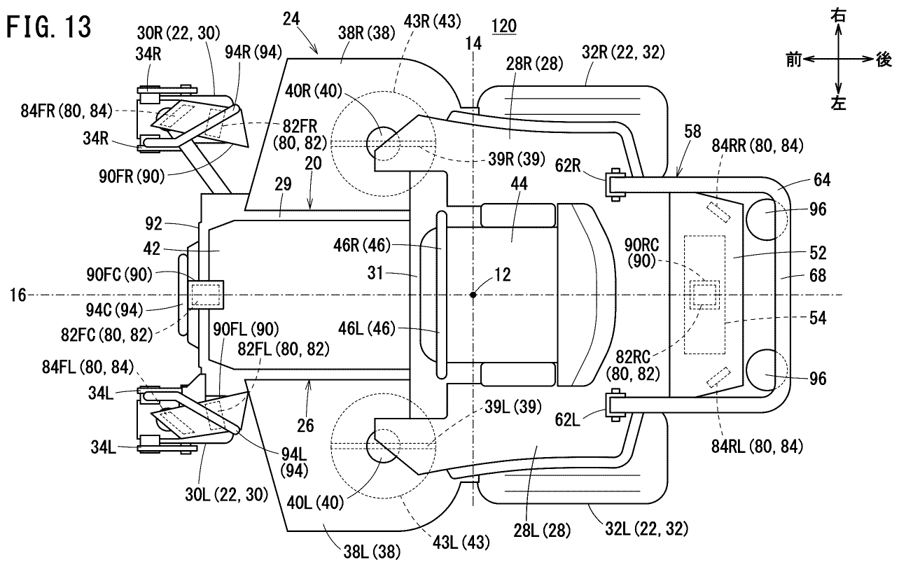

FIG. 13 shows a working machine 120 according to a second exemplary modification. In this working machine 120, in the upper/lower direction, the front right sensor box 90FR is positioned above the right front wheel 30R. In accordance with this feature, in comparison with the present embodiment (refer to FIG. 1 to FIG. 10) and the first embodiment (refer to FIG. 11 and FIG. 12), the distance between the front left radar sensor 84FL and the front right radar sensor 84FR in the left-right direction is wider. Consequently, it is possible to easily obtain the advantageous effects of the first exemplary modification.

The working machines 10, 110 (110F, 110R), and 120 according to the present embodiment, the first exemplary modification, and the second exemplary modification may be constituted in the following manner.

The work deck 24 may include a non-illustrated discharge unit. The discharge unit discharges to the exterior of the working machines 10, 110, and 120 the working target object (the grass) that is cut by the two blades. The discharge unit discharges the working target object, for example, rearwardly of the working machines 10, 110, and 120. Alternatively, the discharge unit may discharge a working discharge object outwardly to the left or outwardly to the right of the working machines 10, 110, and 120. The plurality of LiDAR sensors 82 and the plurality of radar sensors 84 (refer to FIG. 2, FIG. 11, and FIG. 13) may be positioned so as not to overlap with the direction in which the working target object is discharged from the discharge unit. Accordingly, the discharge unit does not discharge the working target object in directions in which the plurality of LiDAR sensors 82 and the plurality of radar sensors 84 are arranged (for example, on the front side of the working machines 10, 110, and 120). In accordance with this feature, it is possible to reduce the influence of the working target object that is discharged from the discharge unit on the recognition by the plurality of LiDAR sensors 82 and the plurality of radar sensors 84 of the surrounding vicinity of the working machines 10, 110, and 120.

As noted previously, the working machines 10, 110, and 120 are capable of undergoing manned traveling by being operated (piloted) by the occupant 18 (refer to FIG. 5 to FIG. 7), and unmanned traveling (autonomous traveling) in which the working machines travel without the occupant 18 riding therein. In this case, the working machines 10, 110, and 120 (refer to FIG. 2, FIG. 11, and FIG. 13), while traveling in an unmanned manner, primarily use the plurality of LiDAR sensors 82 and the plurality of radar sensors 84, and thereby recognize the situation of the surrounding vicinity of the working machines 10, 110, and 120. Further, even while traveling in a manned manner, the working machines 10, 110, and 120 may utilize, as an auxiliary function in order to travel safely, the plurality of LiDAR sensors 82 and the plurality of radar sensors 84, and may thereby recognize the situation of the surrounding vicinity of the working machines 10, 110, and 120.

In the above-described working machines 10, 110, and 120, the weight of the occupant 18 is supported by the seat 44 and the footrest member 42. In the present embodiment, the first exemplary modification, and the second exemplary modification, the working machines 10, 110, 120 may be stand-on type working machines that do not have the seat 44, and which the occupant 18 operates while standing on the footrest member 42. In this case, the footrest member 42 bears the entire weight of the occupant 18 who is in a standing state.

The working machines 10, 110, and 120 may recognize the situation of the operation of the working machines 10, 110, 120 in the working region based on the detection result of the plurality of LiDAR sensors 82 and the plurality of radar sensors 84, and autonomously carry out the operation based on the recognition result.

The three front side sensor boxes 90 on the front side of the working machines 10, 110, and 120 may be constituted in the form of one single unit, and together therewith, the three rear side sensor boxes 90 on the rear side may be constituted in the form of one single unit. In accordance with this feature, it is possible to retrofit the plurality of LiDAR sensors 82 and the plurality of radar sensors 84 with respect to an existing working machine.

The working machines 10, 110, and 120 may be equipped with at least one camera. In accordance with this feature, based on images of the surrounding vicinity of the working machines 10, 110, and 120 acquired by the camera, and the detection result of the plurality of LiDAR sensors 82 and the plurality of radar sensors 84, it is possible to recognize with good accuracy the situation of the operation of the working machines 10, 110, 120 in the working region.

In the working machines 10, 110, and 120, in the permissible position, the safety bar 64 may be inclined frontwardly to an extent that enables the occupant 18 to get in and get out with respect to the working machines 10, 110, and 120.

The following supplementary notes are further disclosed in relation to the above-described embodiment (including the modified examples).

### Supplementary Note 1

In the working machine (10, 110, 110F, 110R, 120) there are provided the vehicle wheels (22), the working unit (24), and the recognition unit (80) that recognizes the surrounding vicinity of the working machine.

According to the present invention, the situation of the surrounding vicinity around the working machine (for example, the working region in which the working machine performs work) can be easily recognized. Accordingly, based on the recognition result of the recognition unit, at least one from among either one of autonomous traveling and autonomous operation of the working machine becomes possible.

### Supplementary Note 2

In the working machine according to Supplementary Note 1, the recognition unit may include the front part recognition unit (82FL, 82FC, 82FR, 84FL, 84FR) that is disposed frontwardly with respect to the front-rear center (14) that is the center in the front-rear direction of the working machine.

In accordance with this feature, it is possible to effectively recognize the situation of the surrounding vicinity (for example, more frontwardly than the front-rear center) of the working machine. As a result, blind spots frontwardly of the working machine can be made fewer.

### Supplementary Note 3

In the working machine according to Supplementary Note 2, the front part recognition unit may be disposed, in a left-right direction of the working machine, in closer proximity to the center line (16) than the end part of the working unit in the left-right direction, the center line passing through the left-right center, which is the center in the left-right direction of the working machine, and extending in the front-rear direction.

In accordance with this feature, it is possible to reduce contact between the working target object and the surrounding objects that exist more on the outer sides in the left-right direction than the working unit, and the front part recognition unit.

### Supplementary Note 4

In the working machine according to Supplementary Note 2 or 3, the front part recognition unit may include the first front part recognition unit (84FL, 84FR) that recognizes the surrounding vicinity of the working machine recognized by the first recognition mechanism, and the second front part recognition unit (82FL, 82FC, 82FR) disposed in close proximity to the first front part recognition unit, and that recognizes the surrounding vicinity of the working machine recognized by the second recognition mechanism that differs from the first recognition mechanism.

In accordance with this feature, based on the recognition mechanisms that differ from each other, it is possible to effectively recognize the situation of the surrounding vicinity of the working machine.

### Supplementary Note 5

In the working machine according to Supplementary Note 4, the second front part recognition unit may have a wider recognition range (86) than the first front part recognition unit, and further, may be disposed at a higher position than the first front part recognition unit.

Since the second front part recognition unit, which has a wider recognition range than the first front recognition unit, is disposed at a higher position than the first front part recognition unit, a larger space can be used as the recognition range.

### Supplementary Note 6

In the working machine according to Supplementary Note 4, the second front part recognition unit may have a higher distance measurement ability than the first front part recognition unit, and further, may be disposed at a higher position than the first front part recognition unit.

Since the second front part recognition unit, which has a higher distance measurement ability than the first front part recognition unit, is disposed at a higher position than the first front part recognition unit, it is possible to cause the distance measurement ability with respect to a larger space to be improved.

### Supplementary Note 7

In the working machine according to Supplementary Note 4, the first front part recognition unit may have a higher tolerance to the recognition environment than the second front part recognition unit, and further, may be disposed at a lower position than the second front part recognition unit.

Since the first front part recognition unit, which has a higher tolerance to the recognition environment than the second front part recognition unit, is positioned at a lower position than the second front part recognition unit, it is possible to effectively recognize foreign objects and the like that exist on the ground surface in front of the direction of travel of the working machine, and further, that have a possibility of colliding with the working machine.

### Supplementary Note 8

In the working machine according to Supplementary Note 4, the first front part recognition unit may have a higher tolerance to the recognition environment than the second front part recognition unit, and further, may be disposed more frontwardly than the second front part recognition unit.

Since the first front part recognition unit, which has a higher tolerance to the recognition environment than the second front part recognition unit, is disposed at a more frontward position than the second front part recognition unit, it is possible to effectively recognize foreign objects and the like that exist on the ground surface in front of the direction of travel of the working machine, and further, that have a possibility of colliding with the working machine.

### Supplementary Note 9

In the working machine according to any one of Supplementary Notes 2 to 8, the vehicle wheels may include the front wheels (30) that are disposed frontwardly with respect to the front-rear center, and the front part recognition unit may be disposed more rearwardly than the front end part of the front wheels.

In accordance with this feature, while the working machine is moving forward, it is possible to reduce the chance of foreign objects or the like colliding with the recognition unit.

### Supplementary Note 10

In the working machine according to Supplementary Note 9, the front part recognition unit may be disposed upwardly of the vehicle wheels in the vertical direction of the working machine, and further, in a top view, may be disposed at a position that overlaps with the front wheels.

In accordance with this feature, the risk of foreign objects or the like colliding with the front part recognition unit while the working machine is moving forward can be reduced, while effectively recognizing the foreign objects or the like that exist on the ground surface frontwardly in the direction of travel of the working machine, and further, that have a possibility of colliding with the working machine.

### Supplementary Note 11

In the working machine according to Supplementary Note 10, there may further be provided the riding section (42, 44) in which the occupant (18) rides, wherein, at a time when viewed from the occupant who is riding in the riding section, the front part recognition unit may be disposed in a manner so that at least a portion of the front wheels is positioned at a position that does not overlap with the front part recognition unit.

In accordance with this feature, the occupant who is riding in the riding section is capable of visually perceiving the front wheels, the surface (the ground surface) on which the front wheels roll, and the front part recognition unit.

### Supplementary Note 12

In the working machine according to any one of Supplementary Notes 2 to 11, there may further be provided the guard member (94) that is disposed more frontwardly than the front end part of the front part recognition unit, and further, that protects the front part recognition unit.

In accordance with this feature, it is possible to effectively protect the front part recognition unit from foreign objects or the like that exist on the ground surface frontwardly in the direction of travel of the working machine, and further, that have a possibility of colliding with the recognition unit.

### Supplementary Note 13

In the working machine according to any one of Supplementary Notes 2 to 12, there may further be provided the footrest member (42) on which the feet (48) of the occupant who is riding in the working machine are placed, and the front part recognition unit may be disposed at a higher position than the footrest member.

In accordance with this feature, it is possible to reduce the possibility of the front part recognition unit coming into contact with the feet of the occupant. Further, it is possible to reduce the possibility of the front part recognition unit coming into contact and getting dirty with the feet of the occupant.

### Supplementary Note 14

In the working machine according to Supplementary Note 13, the front part recognition unit may be disposed at a position that avoids a line of movement (50) of the occupant when getting in and getting out of the working machine between the footrest member and the exterior of the working machine.

In accordance with this feature, at a time when the occupant is getting in and getting out of the working machine, it is possible to reduce the possibility of the front part recognition unit coming into contact with the feet of the occupant. Further, it is possible to effectively reduce the possibility of the front part recognition unit coming into contact and getting dirty with the feet of the occupant.

### Supplementary Note 15

In the working machine according to Supplementary Note 14, the working unit may include the extending portion (38L, 38R) that extends more toward the outer side in the left-right direction than the end part of the footrest member in the left-right direction of the working machine, and the front part recognition unit may be disposed in a manner so that more on a front side than the extending portion, and further, more on an outer side in the left-right direction than the end part of the front part recognition unit in the left-right direction, there is a region in which, in a top view, the moving surface on which the working machine moves and the working machine do not overlap.

In accordance with this feature, without placing his or her feet on the extending portion and the recognition unit, it is possible for the occupant to get in and get out of the working machine, between the region in which the moving surface and the working machine do not overlap, and the footrest member.

### Supplementary Note 16

In the working machine according to any one of Supplementary Notes 2 to 15, the front part recognition unit may be positioned in a manner so that the center of the recognition range of the front part recognition unit is oriented in the left-right direction and the rearward direction of the working machine.

In accordance with this feature, even in the case that the recognition unit is disposed in the front part region of the working machine, it is possible to recognize the left-right direction and the rearward direction of the working machine.

### Supplementary Note 17

In the working machine according to Supplementary Note 16, the vehicle wheels may include the left vehicle wheels (30L, 32L) that are disposed more on the left side than the center line that passes through the left-right center that is the center in the left-right direction and extends in the front-rear direction, and the right vehicle wheels (30R, 32R) that are disposed more on the right side than the center line, and the recognition unit may be disposed in closer proximity to the center line than the left end part of the left vehicle wheel, or alternatively, in closer proximity to the center line than the right end part of the right vehicle wheel.

In accordance with this feature, it is possible to reduce contact between the working target object and the surrounding objects that exist more on the outer sides in the left-right direction of the working machine than the left vehicle wheel and the right vehicle wheel, and the front part recognition unit.

### Supplementary Note 18

In the working machine according to any one of Supplementary Notes 2 to 17, the recognition unit may further include the rear part recognition unit (82RC, 84RL, 84RR) that is disposed rearwardly with respect to the front-rear center.

In accordance with this feature, it is possible to effectively recognize the situation of the surrounding vicinity (for example, more rearwardly than the front-rear center) of the working machine.

### Supplementary Note 19

In the working machine according to Supplementary Note 18, the rear part recognition unit may be disposed at a higher position than the front part recognition unit.

Since the rear part recognition unit is disposed at a higher position than the front part recognition unit, a larger space can be used as the recognition range.

### Supplementary Note 20

In the working machine according to Supplementary Note 19, the recognition unit may have one or more of the front part recognition units, and one or more of the rear part recognition units, and the number of the rear part recognition units may be less than the number of the front part recognition units.

Since a smaller number of the rear part recognition units are arranged at a higher position than the front part recognition units, the recognition range of the rear part recognition units can be made wider, even if the number of the rear part recognition units is small.

### Supplementary Note 21

In the working machine according to any one of Supplementary Notes 1 to 20, the recognition unit may include, in a top view, the left part recognition unit (82FL, 84FL, 84RL) that is disposed on the left side with respect to the center line that passes through the left-right center that is the center in the left-right direction of the working machine and extends in the front-rear direction of the working machine, and the right part recognition unit (82FR, 84FR, 84RR) that is disposed on the right side with respect to the center line.

In accordance with this feature, it is possible to effectively recognize the situation of the surrounding vicinity (for example, more on the left side and the right side than the left-right center) of the working machine.

### Supplementary Note 22

In the working machine according to Supplementary Note 21, the left part recognition unit may be disposed in closer proximity to the center line than the left end part of the working unit in the left-right direction, and the right part recognition unit may be disposed in closer proximity to the center line than the right end part of the working unit in the left-right direction.

In accordance with this feature, it is possible to reduce contact between the working target object and the surrounding objects that exist more on the outer sides in the left-right direction than the working unit, and the left part recognition unit and the right part recognition unit.

### Supplementary Note 23

In the working machine according to Supplementary Note 21 or 22, the vehicle wheels may include the left vehicle wheel disposed more on the left side than the center line, and the right vehicle wheel disposed more on the right side than the center line, the left part recognition unit may be disposed in closer proximity to the center line than the left end part of the left vehicle wheel in the left-right direction, and the right part recognition unit may be disposed in closer proximity to the center line than the right end part of the right wheel in the left-right direction.

In accordance with this feature, it is possible to reduce contact between the working target object and the surrounding objects that exist more on the outer sides in the left-right direction of the working machine than the left vehicle wheel and the right vehicle wheel, and the left part recognition unit and the right part recognition unit.

### Supplementary Note 24

In the working machine according to any one of Supplementary Notes 21 to 23, the left part recognition unit may include the left front part recognition unit (82FL, 84FL) that is disposed frontwardly with respect to the front-rear center that is the center in the front-rear direction, and the left rear part recognition unit (84RL) that is disposed rearwardly with respect to the front-rear center that is the center in the front-rear direction, and the right part recognition unit may include the right front part recognition unit (82FR, 84FR) that is disposed frontwardly with respect to the front-rear center, and the right rear part recognition unit (84RR) that is disposed rearwardly with respect to the front-rear center.

In accordance with this feature, it is possible to more effectively recognize the situation of the surrounding vicinity of the working machine.

### Supplementary Note 25

In the working machine according to Supplementary Note 24, the left rear part recognition unit may be disposed in a manner so that the distance between the left rear part recognition unit and the center line is smaller than the distance between the left front part recognition unit and the center line, and the right rear part recognition unit may be disposed in a manner so that the distance between the right rear part recognition unit and the center line is smaller than the distance between the right front part recognition unit and the center line.

The distance between the left front part recognition unit and the right front part recognition unit in the left-right direction is different from the distance between the left rear part recognition unit and the right rear part recognition unit in the left-right direction. In accordance with this feature, at a time when a plurality of the working machines are aligned in a front-to-rear manner, it is possible to prevent interference from occurring between the rear part recognition units (the left rear recognition unit and the right rear part recognition unit) of the frontwardly located working machine, and the front part recognition units (the left front part recognition unit and the right front part recognition unit) of the rearwardly located working machine.

The distance between the left front part recognition unit and the right front part recognition unit in the left-right direction is greater than the distance between the left rear part recognition unit and the right rear part recognition unit in the left-right direction. In accordance with this feature, it is possible to make the recognition ranges of the left front part recognition unit and the right front part recognition unit wider in the left-right direction than the recognition ranges of the left rear part recognition unit and the right rear part recognition unit. As a result, in a working machine that moves frontwardly more frequently than rearwardly, and further, in which the forward speed thereof is faster than the rearward speed, the recognition range in the frontward direction of the working machine can be easily made wider.

### Supplementary Note 26

In the working machine according to any one of Supplementary Notes 21 to 25, there may further be provided the riding section (44) in which the occupant rides, and the protective member (58) that protects the occupant who is riding in the riding section, wherein the protective member may be provided to be capable of moving between the first position that is capable of protecting the occupant who is riding in the riding section, and the second position that is not capable of protecting the occupant, the left part recognition unit may be the left rear part recognition unit that is disposed rearwardly with respect to the front-rear center that is the center in the front-rear direction, the right part recognition unit may be the right rear part recognition unit that is disposed rearwardly with respect to the front-rear center, and the left rear part recognition unit and the right rear part recognition unit may be disposed more frontwardly than the rear end part of the protective member that is positioned at the second position.

At a time when the working machine is not in use and further is stopped, since the occupant is not riding in the riding section, the protective member is positioned in the second position. In accordance with this feature, while the working machine is stopped, the protective member receives an external force from rearwardly of the working machine. As a result, while the working machine is stopped, it is possible to suppress the external force from rearwardly of the working machine from being applied to the left rear recognition unit and the right rear recognition unit.

### Supplementary Note 27

In the working machine according to any one of Supplementary Notes 1 to 26, the recognition unit may be disposed at a position that, in a top view, does not overlap with the working unit.

In accordance with this feature, it is possible to suppress a decrease in the recognition accuracy of the recognition unit and a progression in the deterioration of the recognition unit caused by operation of the working unit and vibrations during working, as well as flying objects or the like accompanying the operation of the working unit.

### Supplementary Note 28

In the working machine according to Supplementary Note 27, there may further be provided the machine body (20) or the framework, the machine body or the framework may include the first portion (29) and the second portion (92), the working unit may be fixed to the first portion, and the recognition unit may be fixed to the second portion.

Since the working unit and the recognition unit are fixed to different parts of the vehicle body or the framework, it is possible to effectively suppress the operation of the working unit and the vibrations during working from being transmitted to the recognition unit.

### Supplementary Note 29

In the working machine according to Supplementary Note 27 or 28, the working unit may include the discharge unit that discharges the working target object to the exterior of the working machine, and the recognition unit may be disposed at a position that does not overlap with the direction in which the working target object is discharged from the discharge unit.

In accordance with this feature, it is possible to reduce the influence of the working target object that is discharged from the discharge unit on the recognition by the recognition unit of the situation of the surrounding vicinity of the working machine.

Moreover, it should be noted that the present invention is not limited to the disclosure described above, and various configurations can be adopted therein without departing from the essence and gist of the present invention.

1. A working machine, comprising:
vehicle wheels;
a working unit; and
a recognition unit configured to recognize a surrounding vicinity of the working machine.

2. The working machine according to claim 1, wherein the recognition unit includes at least one of a front part recognition unit that is disposed frontwardly with respect to a front-rear center that is a center in a front-rear direction of the working machine and a rear part recognition unit that is disposed rearwardly with respect to the front-rear center.

3. The working machine according to claim 2, wherein the front part recognition unit comprises:
a first front part recognition unit configured to recognize a surrounding vicinity of the working machine recognized by a first recognition mechanism; and
a second front part recognition unit disposed in close proximity to the first front part recognition unit, and configured to recognize a surrounding vicinity of the working machine recognized by a second recognition mechanism that differs from the first recognition mechanism.

4. The working machine according to claim 3, wherein the second front part recognition unit is disposed at a higher position than the first front part recognition unit, and
the second front part recognition unit has a wider recognition range than the first front part recognition unit, a higher distance measurement ability than the first front part recognition unit, or a wider recognition range and a higher distance measurement ability than the first front part recognition unit.

5. The working machine according to claim 3, wherein the first front part recognition unit has a higher tolerance to a recognition environment than the second front part recognition unit, and
the first front part recognition unit is disposed at a lower position than the second front part recognition unit, at a position more frontward than the second front part recognition unit, or at a position lower and more frontward than the second front part recognition unit.

6. The working machine according to claim 2, wherein:
the vehicle wheels include a front wheel disposed frontwardly with respect to the front-rear center; and
the front part recognition unit is disposed more rearwardly than a front end part of the front wheel.

7. The working machine according to claim 6, wherein the front part recognition unit is disposed upwardly of the vehicle wheels in a vertical direction of the working machine, and further, in a top view, is disposed at a position that overlaps with the front wheel.

8. The working machine according to a claim 2, wherein the front part recognition unit is positioned in a manner so that a center of a recognition range of the front part recognition unit is oriented in a left-right direction and a rearward direction of the working machine.

9. The working machine according to claim 8, wherein:
the vehicle wheels include a left vehicle wheel that is disposed more on a left side than a center line that passes through a left-right center that is a center in the left-right direction and extends in the front-rear direction, and a right vehicle wheel that is disposed more on a right side than the center line; and
the front part recognition unit is disposed in closer proximity to the center line than a left end part of the left vehicle wheel, or alternatively, in closer proximity to the center line than a right end part of the right vehicle wheel.

10. The working machine according to claim 2, wherein the rear part recognition unit is disposed at a higher position than the front part recognition unit.

11. The working machine according to claim 10, wherein:
the recognition unit has one or more of the front part recognition units, and one or more of the rear part recognition units; and
a number of the rear part recognition units is less than a number of the front part recognition units.

12. The working machine according to claim 1, wherein the recognition unit comprises in a top view:
a left part recognition unit disposed on a left side with respect to a center line that passes through a left-right center that is a center in the left right direction of the working machine and extends in the front-rear direction of the working machine; and
a right part recognition unit disposed on a right side with respect to the center line.

13. The working machine according to claim 12, wherein:
the left part recognition unit comprises:
a left front part recognition unit disposed frontwardly with respect to a front-rear center that is a center in the front-rear direction; and
a left rear part recognition unit disposed rearwardly with respect to the front-rear center;
the right part recognition unit comprises:
a right front part recognition unit disposed frontwardly with respect to the front-rear center; and
a right rear part recognition unit disposed rearwardly with respect to the front-rear center.

14. The working machine according to claim 12, further comprising:
a riding section in which an occupant rides; and
a protective member configured to protect the occupant who is riding in the riding section;
wherein the protective member is provided to be capable of moving between a first position that is capable of protecting the occupant who is riding in the riding section, and a second position that is not capable of protecting the occupant;
the left part recognition unit is a left rear part recognition unit disposed rearwardly with respect to a front-rear center that is a center in the front-rear direction;
the right part recognition unit is a right rear part recognition unit disposed rearwardly with respect to the front-rear center; and
the left rear part recognition unit and the right rear part recognition unit are disposed more frontwardly than a rear end part of the protective member that is positioned at the second position.

15. The working machine according to claim 1, wherein the recognition unit is disposed at a position that, in a top view, does not overlap with the working unit.

16. The working machine according to claim 1, further comprising:
a machine body or a framework;
the machine body or the framework includes a first portion and a second portion;
the working unit is fixed to the first portion; and
the recognition unit is fixed to the second portion.
